(19) United States
(12) Patent Application Publication
(10) Pub. No.: US 2025/0371719 A1
(43) Pub. Date: Dec. 4, 2025

(54) Motion Data Processing Method and Apparatus, Product, Device, and Medium

(71) Applicant: Tencent Technology (Shenzhen) Company Limited, Shenzhen (CN)

(72) Inventors: Tiancai Chen, Shenzhen (CN); Tianyuan Chang, Shenzhen (CN); Rong Zhang, Shenzhen (CN); Zijiao Zeng, Shenzhen (CN)

(21) Appl. No.: 19/270,012

(22) Filed: Jul. 15, 2025

Related U.S. Application Data
(63) Continuation of application No. PCT/CN2024/101259, filed on Jun. 25, 2024.

(30) Foreign Application Priority Data
Jun. 26, 2023 (CN) 2023107634825

(51) Int. Cl. G06T 7/246; G06T 5/70; G06T 7/64; G06V 10/42; G06V 10/80

(52) U.S. Cl. CPC G06T 7/246; G06T 5/70; G06T 7/64; G06V 10/42; G06V 10/806; G06T 2207/20044

(57) ABSTRACT

Motion data processing techniques are described herein. The motion data processing technique may include identifying N motion points of a second object model each corresponding to one or more base bones in M base bones, and converting first reference positions of the N motion points and second reference positions of the M bones, to generate a global prediction feature. The global prediction feature may be configured for reflecting a global position feature between the N motion points and corresponding base bones, position features of the M base bones, and structural features of bone chains in which the base bones corresponding to the motion points are located. The techniques may further include predicting a motion binding parameter between each motion point and the corresponding base bone based on the global prediction feature, where any motion point is configured for moving with a corresponding base bone according to a motion binding parameter between the motion point and the corresponding base bone. This can improve efficiency and accuracy of obtaining a motion binding parameter between a motion point and a corresponding base bone.

### CROSS-REFERENCE TO RELATED APPLICATIONS

This application is a Continuation Application of PCT Application PCT/CN2024/101259, filed Jun. 25, 2024, which claims priority to Chinese Patent Application No. 2023107634825, filed Jun. 26, 2023, each entitled “MOTION DATA PROCESSING METHOD AND APPARATUS, PRODUCT, DEVICE, AND MEDIUM” and each of which is incorporated herein by reference in its entirety.

### FIELD

This application relates to the field of computer technologies, and in particular, to a motion data processing method and apparatus, a product, a device, and a medium.

### BACKGROUND

Skinning may generally refer to establishing a binding relationship between a motion point of clothes and a bone of a person, so that subsequently the clothes can move with the person based on the binding relationship.

In an existing application, an artist usually establishes a binding relationship between a motion point of clothes and a bone of a person according to experience that the clothes follows motion of the person. However, there are usually many clothes motion points, and the artist needs to spend a lot of time to establish the binding relationship between the clothes motion points and the bone of the person, resulting in low efficiency of establishing the binding relationship between the clothes motion points and the bone of the person. In addition, because levels of different artists may be different, accuracy of the established binding relationship between the clothes motion points and the bone of the person cannot be ensured.

### SUMMARY

This application provides a motion data processing method and apparatus, a product, a device, and a medium, to improve efficiency and accuracy of obtaining a motion binding parameter between a motion point and a corresponding base bone.

An aspect described herein provides a motion data processing method. The method includes:
obtaining a first object model, the first object model including M base bones or some of the M base bones, and M being a natural number;
obtaining a second object model, the second object model including N motion points, each motion point of the N motion points respectively corresponding to one or more base bones of the M base bones, the N motion points being configured for defining motion of the second object model, and N being a natural number;
determining a first reference position of each motion point and a second reference position of each base bone of the M base bones;
performing conversion processing on the first reference position and the second reference position, to generate a global prediction feature corresponding to the N motion points, the global prediction feature being configured for reflecting a global position feature between the N motion points and corresponding base bones, position features of the M base bones, and structural features of bone chains in which the base bones corresponding to the N motion points are located; and
determining a motion binding parameter between each motion point and a corresponding base bone based on the global prediction feature, any motion point in the N motion points being configured for following a corresponding base bone to motion according to a motion binding parameter between the motion point and the corresponding base bone.

An aspect described herein provides a motion data processing apparatus. The apparatus includes:
a first obtaining module, configured to obtain a first object model, the first object model including M base bones or some of the M base bones, and M being a natural number;
a second obtaining module, configured to obtain a second object model, the second object model including N motion points, each motion point of the N motion points respectively corresponding to one or more base bones of the M base bones, the N motion points being configured for defining motion of the second object model, and N being a natural number;
a first determining module, configured to determine a first reference position of each motion point and a second reference position of each base bone of the M base bones;
a conversion module, configured to perform conversion processing on the first reference position and the second reference position, to generate a global prediction feature corresponding to the N motion points, the global prediction feature being configured for reflecting a global position feature between the N motion points and corresponding base bones, position features of the M base bones, and structural features of bone chains in which the base bones corresponding to the N motion points are located; and
a second determining module, configured to determine a motion binding parameter between each motion point and a corresponding base bone based on the global prediction feature, any motion point in the N motion points being configured for following a corresponding base bone to motion according to a motion binding parameter between the motion point and the corresponding base bone.

An aspect described herein provides a computer device, including a memory and a processor. The memory stores a computer program. When the computer program is executed by the processor, the processor performs the method in the aspect described herein.

An aspect described herein provides a computer-readable storage medium, having a computer program stored therein, and when the computer program is executed by a processor, the processor performs the method in the foregoing aspect.

According to an aspect described herein, a computer program product is provided, where the computer program product includes a computer program, and the computer program is stored in a computer-readable storage medium. A processor of a computer device reads the computer program from the computer-readable storage medium, and the processor executes the computer program, so that the computer device performs the method provided in various selectable manners such as the foregoing aspect.

Described herein, the first object model and the second object model may be obtained. The first object model may include the M base bones or some of the M base bones. The second object model may include the N motion points. Each motion point may correspond to one or more base bones of the M base bones. The N motion points may be configured for defining motion of the second object model. Therefore, described herein, feature embedding processing may be performed on the first reference positions of the N motion points and the second reference positions of the M bones, to generate the global prediction feature corresponding to the N motion points. The global prediction feature may be configured for reflecting a global position feature between the N motion points and corresponding base bones, position features of the M base bones, and structural features of bone chains in which the base bones corresponding to the N motion points are located. Therefore, described herein, a motion binding parameter between each motion point and a corresponding base bone may be determined based on the global prediction feature. Any motion point in the N motion points may move with a corresponding base bone based on a motion binding parameter between the motion point and the corresponding base bone. It can be learned that, in the method provided described herein, feature embedding processing may be performed on the first reference position of each motion point in the first object model and the second reference position of each motion point and the corresponding base bone in the second object model, to obtain the global prediction feature corresponding to the N motion points. The global prediction feature may include a plurality of features, such as a global position feature between a motion point and a corresponding base bone, position features of M bones, and structural features of bone chains in which the M bones are located. Subsequently, a motion binding parameter between each motion point and a corresponding base bone can be quickly and accurately determined by using the global prediction feature. Any motion point can accurately move with the corresponding base bone based on the motion binding parameter between the motion point and the corresponding base bone.

### BRIEF DESCRIPTION OF THE DRAWINGS

FIG. 1 is a schematic structural diagram of a network architecture according to an aspect described herein.

FIG. 2a is a schematic diagram 1 of a scenario in which an object follows motion according to an aspect described herein.

FIG. 2b is a schematic diagram 2 of a scenario in which an object follows motion according to an aspect described herein.

FIG. 3 is a schematic flowchart of a motion data processing method according to an aspect described herein.

FIG. 4 is a schematic interface diagram of a skinning configuration interface according to an aspect described herein.

FIG. 5a is a schematic interface diagram 1 of a skinning configuration according to an aspect described herein.

FIG. 5b is a schematic interface diagram 2 of a skinning configuration according to an aspect described herein.

FIG. 6a is a schematic interface diagram 1 of a post-processing configuration interface according to an aspect described herein.

FIG. 6b is a schematic interface diagram 2 of a post-processing configuration interface according to an aspect described herein.

FIG. 6c is a schematic interface diagram 3 of a post-processing configuration interface according to an aspect described herein.

FIG. 6d is a schematic interface diagram 4 of a post-processing configuration interface according to an aspect described herein.

FIG. 7 is a schematic diagram of a post-processing effect according to an aspect described herein.

FIG. 8 is a schematic flowchart of a position smoothing method according to an aspect described herein.

FIG. 9 is a schematic diagram of a scenario of position smoothing processing according to an aspect described herein.

FIG. 10 is a schematic diagram of an effect of smoothing a second object model according to an aspect described herein.

FIG. 11 is a schematic flowchart of a feature generation method according to an aspect described herein.

FIG. 12a is a schematic structural diagram 1 of a skinning network according to an aspect described herein.

FIG. 12b is a schematic structural diagram 2 of a skinning network according to an aspect described herein.

FIG. 12c is a schematic structural diagram 3 of a skinning network according to an aspect described herein.

FIG. 12d is a schematic structural diagram 4 of a skinning network according to an aspect described herein.

FIG. 12e is a schematic structural diagram 5 of a skinning network according to an aspect described herein.

FIG. 12f is a schematic structural diagram 6 of a skinning network according to an aspect described herein.

FIG. 12g is a schematic structural diagram 7 of a skinning network according to an aspect described herein.

FIG. 13 is a schematic flowchart of another feature generation method according to an aspect described herein.

FIG. 14 is a schematic flowchart of a network training method according to an aspect described herein.

FIG. 15 is a schematic flowchart of a local skinning method according to an aspect described herein.

FIG. 16 is a schematic interface diagram of configuring local skinning according to an aspect described herein.

FIG. 17a is a schematic structural diagram 1 of a local skinning network according to an aspect described herein.

FIG. 17b is a schematic structural diagram 2 of a local skinning network according to an aspect described herein.

FIG. 17c is a schematic structural diagram 3 of a local skinning network according to an aspect described herein.

FIG. 17d is a schematic structural diagram 4 of a local skinning network according to an aspect described herein.

FIG. 18a is a schematic diagram 1 of an effect of local skinning according to an aspect described herein.

FIG. 18b is a schematic diagram 2 of an effect of local skinning according to an aspect described herein.

FIG. 19 is a schematic structural diagram of a motion data processing apparatus according to an aspect described herein.

FIG. 20 is a schematic structural diagram of a computer device according to an aspect described herein.

### DETAILED DESCRIPTION

This application relates to artificial intelligence related technologies. Artificial intelligence (AI) is a theory, method, technology, and application system that uses a digital computer or a machine controlled by the digital computer to simulate, extend, and expand human intelligence, perceive an environment, obtain knowledge, and use knowledge to obtain an optimal result. In other words, AI is a comprehensive technology in computer science and attempts to understand the essence of intelligence and produce a new intelligent machine that can react in a manner similar to human intelligence. AI is to study the design principles and implementation methods of various intelligent machines, to enable the machines to have the functions of perception, reasoning, and decision-making.

The AI technology is a comprehensive discipline, and relates to a wide range of fields including both hardware-level technologies and software-level technologies. The basic AI technologies generally include technologies such as a sensor, a dedicated AI chip, cloud computing, distributed storage, a big data processing technology, an operating/interaction system, and electromechanical integration. AI software technologies mainly include several major directions such as a computer vision (CV) technology, a speech processing technology, a natural language processing technology, and machine learning/deep learning.

This application mainly relates to machine learning in artificial intelligence. Machine learning (ML) is a multi-field interdiscipline, and relates to a plurality of disciplines such as probability theory, statistics, approximation theory, convex analysis, and algorithm complexity theory. Machine learning specializes in studying how a computer simulates or implements a human learning behavior to obtain new knowledge or skills, and reorganize an existing knowledge structure, so as to keep improving the performance of the computer itself. ML is the core of AI, is a basic way to make the computer intelligent, and is applied to various fields of AI. ML and deep learning generally include technologies such as an artificial neural network, a belief network, reinforcement learning, transfer learning, inductive learning, and learning from demonstrations.

Described herein, the motion binding parameter between each motion point of the second object model and the base bone of the first object model may be automatically and accurately generated by means of machine learning (for example, deep model learning), so that subsequently, the second object model can follow the corresponding base bone to perform corresponding motion based on the motion binding parameter between each motion point and the corresponding base bone. For details, refer to descriptions in the following aspects.

First, all data (for example, all data related to the first object model and the second object model) collected described herein is collected when an object (for example, a user, an institution, or an enterprise) to which the data belongs agrees and gives authorization, and related data needs to be collected, used, and processed according to related laws, regulations, and standards of a related country or region.

Herein, related technical concepts involved described herein are described.

Mesh: may be configured for expression of a digital asset in a three-dimensional (3D) game (or may be another 3D scenario), such as clothes and a scenario. The mesh described herein may refer to the second object model. In other words, the second object model may be constructed and represented based on a mesh.

Maya: is animation software for 3D modeling.

3ds Max: is another type of animation software for 3D modeling.

Skinning: is for establishing a binding weight between a 3D mesh and a bone, that is, establishing a binding relationship between the 3D mesh and the bone.

Linear blend skinning (LBS): is an algorithm in which a bone drives a mesh vertex to move.

Multi-layer perceptron (MLP): is a deep learning module.

Embedding: is to embed a feature (that is, information) of input data into a vector, and use a learned vector to represent the feature of the input data.

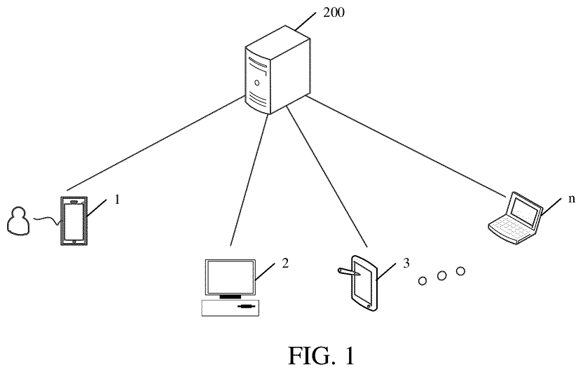

Referring to FIG. 1, FIG. 1 is a schematic structural diagram of a network architecture according to an aspect described herein. As shown in FIG. 1, the network architecture may include a server 200 and a terminal device cluster. The terminal device cluster may include one or more terminal devices. A quantity of the terminal devices is not limited herein. As shown in FIG. 1, the plurality of terminal devices may specifically include a terminal device 1, a terminal device 2, a terminal device 3, . . . , and a terminal device n, where n is a positive integer. As shown in FIG. 1, the terminal device 1, the terminal device 2, the terminal device 3, . . . , and the terminal device n may each establish a network connection to the server 200, so that each terminal device can exchange data with the server 200 by using the network connection.

The server 200 shown in FIG. 1 may be an independent physical server, or may be a server cluster or a distributed system formed by a plurality of physical servers, or may be a cloud server that provides a basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform. The terminal device may be: an intelligent terminal such as a smartphone, a tablet computer, a notebook computer, a desktop computer, an intelligent television, or the like. Specific descriptions of aspects described herein are provided below by using communication between the terminal device 1 and the server 200 as an example.

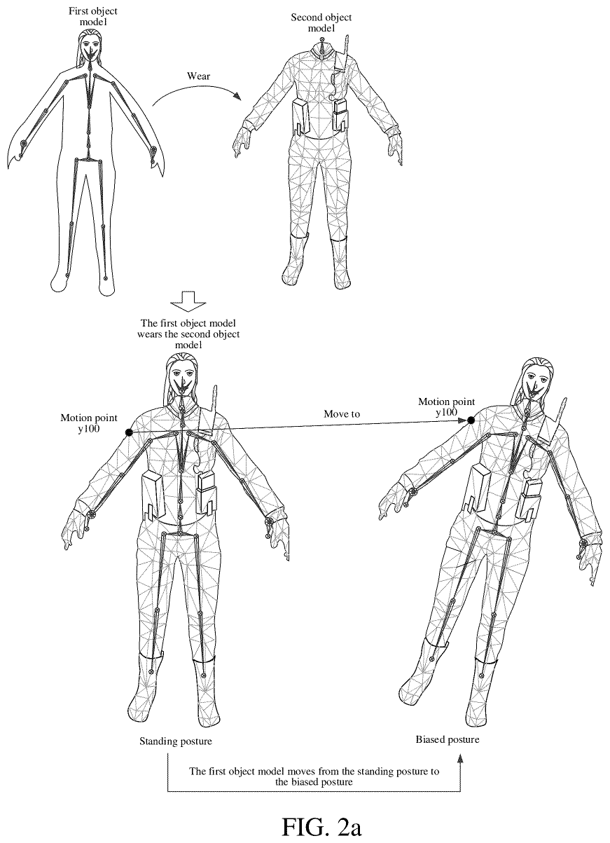

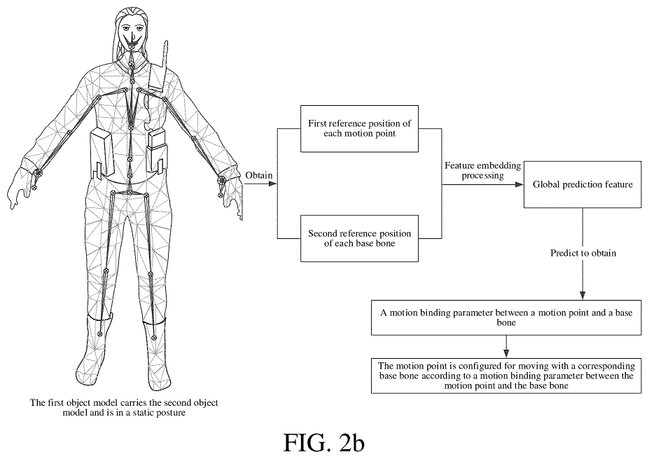

Referring to FIG. 2a to FIG. 2b, FIG. 2a is a schematic diagram 1 of a scenario in which an object follows motion according to an aspect described herein, and FIG. 2b is a schematic diagram 2 of a scenario in which an object follows motion according to an aspect described herein. The terminal device 1 may be a terminal device of an animator (a user). The animator may initiate, on the terminal device 1, a request for skinning a first object model and a second object model. Further, the terminal device 1 may transmit the request to the server 200, and the server 200 may achieve skinning between the first object model and the second object model. The first object model may be an object that can actively move and that is modeled in animation. For example, the first object model may be a virtual character or a virtual monster modeled in a game. The second object model may be an object that follows the first object model to move. For example, the second object model may be clothes that can be worn by the first object model or an accessory carried thereby.

As shown in FIG. 2a, the first object model may be a virtual nude model. The first object model may have several base bones for modeling, and the second object model may be clothes that can be worn by the first object model. Therefore, the second object model may be worn on the first object model. The second object model may be constructed based on a mesh, each vertex of the mesh may be referred to as a motion point of the second object model, and motion of the motion point of the second object model may implement overall motion of the second object model. Each motion point of the second object model may follow the base bone of the first object model to perform corresponding motion.

The first object model may initially have a static posture (which may also be referred to as a start posture, a standard posture, or the like, for example, a standing posture), and the first object model may move from the standing posture to a biased posture. In this case, each motion point of the second object model may also correspondingly move with the base bone of the second object model, such as motion of a motion point y 100.

Corresponding motion performed by the second object model following the first object model may be implemented by using a skinning operation performed by the server 200 on the first object model and the second object model.

A process of skinning, by the server 200, the first object model and the second object model may be shown in FIG. 2b: When the first object model wears the second object model and is in a static posture, the server 200 may obtain reference positions of motion points of the second object model (the reference positions of the motion points may be referred to as first reference positions) and reference positions of base bones of the first object model (the reference positions of the base bones may be referred to as second reference positions). The first reference position of each motion point and the second reference position of each base bone are initial reference positions for skinning the motion point and the base bone.

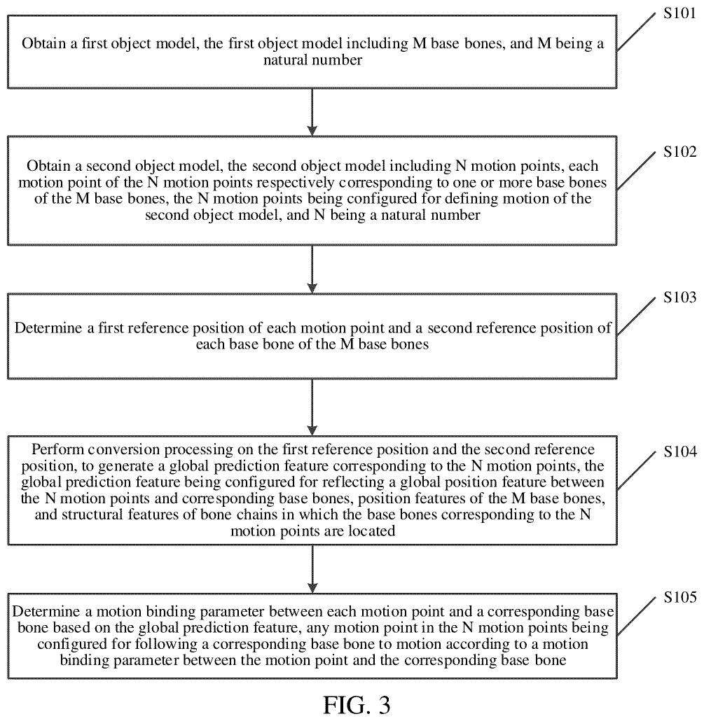

Further, the server 200 may perform conversion processing (which may be feature embedding processing) on the second reference position of each base bone of the first object model and the first reference position of each motion point of the second object model, to obtain the global prediction feature. The global prediction feature is a feature configured for predicting a motion binding parameter (that is, a binding weight) between the base bone of the first object model and the motion point of the second object model. For a specific process of how to perform conversion processing on the second reference position of each base bone of the first object model and the first reference position of each motion point of the second object model, to generate the global prediction feature, refer to related descriptions in the following aspect corresponding to FIG. 3.

A process of predicting the motion binding parameter between the base bone of the first object model and the motion point of the second object model is a process of performing skinning between the first object model and the second object model. Subsequently, the motion point of the second object model may correspondingly move with the base bone of the first object model based on the motion binding parameter between the motion point and the base bone of the first object model.

Described herein, feature embedding processing may be performed on the second reference position of the base bone of the first object model and the first reference position of the motion point of the second object model, to generate the global prediction feature for the motion point of the second object model. Subsequently, the motion binding parameter between each motion point and the corresponding base bone can be quickly and accurately predicted by using the global prediction feature, thereby implementing quick skinning between the first object model and the second object model.

Referring to FIG. 3, FIG. 3 is a schematic flowchart of a motion data processing method according to an aspect described herein. This aspect described herein may be performed by a motion data processing device. The motion data processing device may be a computer device or a computer device cluster including a plurality of computer devices. The computer device may be a server, a terminal device, or another device. This is not limited. The motion data processing device may be briefly referred to as a processing device below. As shown in FIG. 3, the method may include:

Operation S101: Obtain a first object model, the first object model including M base bones, and M being a natural number.

In some aspects, the processing device may obtain a modeled first object model. The first object model may be an object that can actively move in an animation or a game (or may be another scenario). For example, the first object model may be a virtual character or monster constructed in a game (for example, a constructed 3D character model or monster model). The first object model may have several base bones obtained through modeling. The first object model may move by using the base bone of the first object model. A quantity of base bones included in the first object model may be determined according to an actual application scenario. This is not limited. Described herein, the first object model may include (that is, have) M base bones or some subset base bones of the M base bones, where M is a natural number, and a specific value of M may be determined according to an actual application scenario.

In other words, the M base bones may be all base bones of the first object model. Alternatively, in some special scenarios, the M bones may further include an auxiliary bone. The auxiliary bone might not be a base bone of the first object model, and the auxiliary bone may be a base bone configured for assisting the second object model to move. For example, if the second object model is a skirt with a fluffing hemline, the auxiliary bone may be a base bone configured for supporting the hemline, that is, the auxiliary bone may be configured for causing the hemline to be fluffed. A quantity of auxiliary bones may also be determined according to an actual application scenario. This is not limited. In some scenarios, the second object model may alternatively have no auxiliary bone. In this case, the M bones might not include the auxiliary bone of the second object model.

In conclusion, the M base bones may include all bones that are in the first object model and that affect motion of the N motion points (and therefore, the M base bones may include all or some base bones of the first object model). In addition, according to a requirement in an actual application scenario, the M base bones may further include or might not include an auxiliary bone configured for assisting the second object model to perform motion.

Operation S102: Obtain a second object model, the second object model including N motion points, each motion point of the N motion points respectively corresponding to one or more base bones of the M base bones, the N motion points being configured for defining motion of the second object model, and N being a natural number.

In some aspects, the processing device may further obtain the second object model. The second object model may be any object that can move with the first object model in an animation or a game (or another scenario). For example, the second object model may be clothes or an ornament worn by the first object model, or any detachable article that can be carried by the first object model. The second object model may be constructed and represented based on a mesh.

The second object model may include (that is, have) N motion points. N is a natural number. A specific value of N may be determined according to an actual application scenario. The motion point of the second object model may be a vertex (which may be referred to as a mesh vertex) of a mesh configured for representing the second object model. The mesh may be a polygon mesh such as a triangular mesh. The second object model may move based on a motion point of the second object model. In other words, each motion point of the second object model is made to move, so that corresponding motion in the whole second object model can be implemented.

The N motion points of the second object model define (or represent) motion of the second object model. In other words, the N motion points of the second object model may be configured for describing/referring to motion (for example, a motion track) of the second object model. Therefore, the N motion points of the second object model may move with the M base bones.

More, each motion point of the N motion points may separately correspond to one or more base bones of the M base bones. A base bone corresponding to any motion point may include all base bones that are in the M base bones and that may affect motion of the any motion point. In other words, any motion point may move with reference to motion of a corresponding base bone. Any motion point may have one or more corresponding base bones. Quantities of base bones corresponding to different motion points may be the same or different. This is not limited.

In some aspects, a base bone corresponding to any motion point may be some base bones in the M base bones. For example, the base bone corresponding to any motion point may be a plurality of base bones that are in the M base bones and that are relatively close to the motion point (for example, 30 base bones closest to the any motion point). Alternatively, a base bone corresponding to any motion point may include all base bones of the M base bones.

However, most of the time, because not all the M base bones affect motion of a motion point, some base bones are selected from the M base bones as base bones corresponding to the motion point, and subsequently, only motion binding parameters between the motion point and the base bones corresponding to the motion point may be predicted and determined, thereby reducing an amount of calculation for predicting the motion binding parameters between the motion point and the base bones.

In some aspects, base bones respectively corresponding to the N motion points in the M base bones may be configured in advance. Therefore, when the first object model and the second object model are obtained, the base bone respectively corresponding to each motion point may be directly obtained (or may be referred to as identified). Alternatively, base bones corresponding to the N motion points in the M base bones may be configured (for example, selected) in real time by a technician who skins the first object model and the second object model and provided to the processing device. This is not limited described herein.

For example, a picture of the first object model carrying (skinned with) the second object model may be visually displayed in animation software. Therefore, the N motion points and the M base bones may both be visualized. Therefore, in some aspects, the base bone corresponding to each motion point may be selected by a corresponding technician from the animation software for each motion point to be visualized. For example, the selection may be performed by using a whole circle selection operation on several displayed base bones or a single selection operation on each base bone, or the selection may be performed automatically by the processing device by using a specified related selection policy (for example, a policy of selecting a target quantity of base bones having a smallest distance to the motion point as the base bones corresponding to the motion point). In some aspects, actually, the base bone corresponding to each motion point may be selected in any feasible manner. Specifically, how to select the base bone corresponding to each motion point may be determined according to an actual application scenario, and this is not limited.

By using the foregoing process, the processing device can obtain the one or more base bones respectively corresponding to the N motion points in the M base bones, and each motion point can move with its own base bone.

Operation S103: Determine a first reference position of each motion point and a second reference position of each base bone of the M base bones.

In some aspects, each motion point of the N motion points and each base bone of the M base bones have a start position. A motion point may have a start position, a base bone may have a start position, and a start position of a base bone may be a specified start position of a particular point (for example, a center point or a vertex of the base bone) on the base bone. The start position may be a position in which the second object model carries the first object model and holds the second object model in a start position (which may also be referred to as a static position or a standard position). If the second object model is clothes worn by the first object model, and the start position is a standard standing position of the first object model, start positions of the N motion points and start positions of the M base bones may be positions in which the second object model is worn by the first object model and when the second object model is standing. In some aspects, the start positions of the N motion points and the M base bones may be position coordinates in a pre-established standard coordinate system (which may be three-dimensional). For example, the standard coordinate system may be a world coordinate system.

Each motion point of the N motion points and each base bone of the M base bones may further have respective reference positions. In some aspects, the reference position of each base bone may be a start position of the base bone.

However, if the second object model is clothes, the second object model may be very complex in many scenarios (because clothes are very complex), the clothes may have many wrinkles or a plurality of layers superposed, and some excessively detailed forms (for example, a form of wrinkles or superposed one by one) of the clothes may affect the skin effect, causing an unsmooth and inaccurate skin between the first object model and the second object model.

Therefore, described herein, smoothing processing (that is, a smoothing operation) may be performed on the start positions of the N motion points without changing the overall form of the second object model, to obtain a smoothed start position of each motion point, and further, the smoothed start position of each motion point is used as a reference position of each motion point. Certainly, in some cases, if a form of the second object model is very regular (that is, very ordered), and there are not many wrinkles or details, the start positions of the N motion points may be directly used as reference positions of the N motion points, and a specific determining manner of the reference positions of the N motion points may be determined according to an actual application scenario.

The smoothing processing is mainly to make a relatively detailed part of the second object model more flat and easier to perform skinning, without changing the overall form of the second object model. Therefore, a difference (that is, a distance) between a smoothed start position of each motion point and a start position of each motion point is usually very small. Therefore, regardless of whether the reference position of each motion point is the start position of the motion point or a position obtained by performing smoothing processing on the start position of the motion point, the reference position of each motion point may be configured for reflecting the start position of the motion point to some extent.

The reference positions of the N motion points may be referred to as first reference positions, and reference positions of the M base bones may be referred to as second reference positions. Subsequently, described herein, skinning between the first object model and the second object model may be implemented based on the first reference position of each motion point and the second reference position of each bone, that is, a motion binding parameter between each motion point and each base bone is generated. The motion binding parameter represents a binding relationship between each motion point and each base bone. A motion point may move with a corresponding base bone based on the motion binding parameter between the motion point and the corresponding base bone. The motion binding parameter between the motion point and the base bone may be a binding weight between the motion point and the base bone, and the binding weight may be configured for determining how the motion point moves with the corresponding base bone.

The first reference position of each motion point and the second reference position of each base bone may be represented by using corresponding position coordinates in the foregoing standard coordinate system.

By performing smoothing processing on the start positions of the N motion points, some local forms that are excessively detailed in the second object model may be smoothed, facilitating subsequent learning of relatively smooth form features in the second object model by means of deep learning, and subsequent overall skinning may be performed on the second object model more accurately and stably, so that a skinning effect (for example, a generated motion binding parameter) can also be smoother and accurate. That is, there may be no excessively sudden change between generated motion binding parameters because a sudden motion binding parameter is usually random and inaccurate.

The reference positions of the N motion points that are obtained by smoothing the start positions of the N motion points are configured for subsequently performing skinning between the first object model and the second object model. After skinning is completed, each motion point moves with a corresponding base bone based on a respective start position and a corresponding motion binding parameter. In other words, smoothing processing is performed on the start positions of the N motion points, to subsequently perform more accurate and stable skinning (for example, generate a more accurate motion binding parameter) on the first object model and the second object model by means of deep learning, without changing the form of the second object model when the second object model moves after skinning is completed.

For a specific process of performing smoothing processing on the start positions of the N motion points, to obtain the first reference positions of the N motion points, references may also be made to the description in the following aspect corresponding to FIG. 8.

To enable a user (such as an artist or an animator) to use the technical solution described herein more conveniently, this application further develops a plug-in (which may be referred to as a skinning plug-in and may belong to an application program, a web page program, or the like) of Maya and 3ds Max. The skinning plug-in may move on a front end (such as on a terminal device), so that the user can correspondingly configure a related requirement of skinning between the first object model and the second object model on the skinning plug-in.

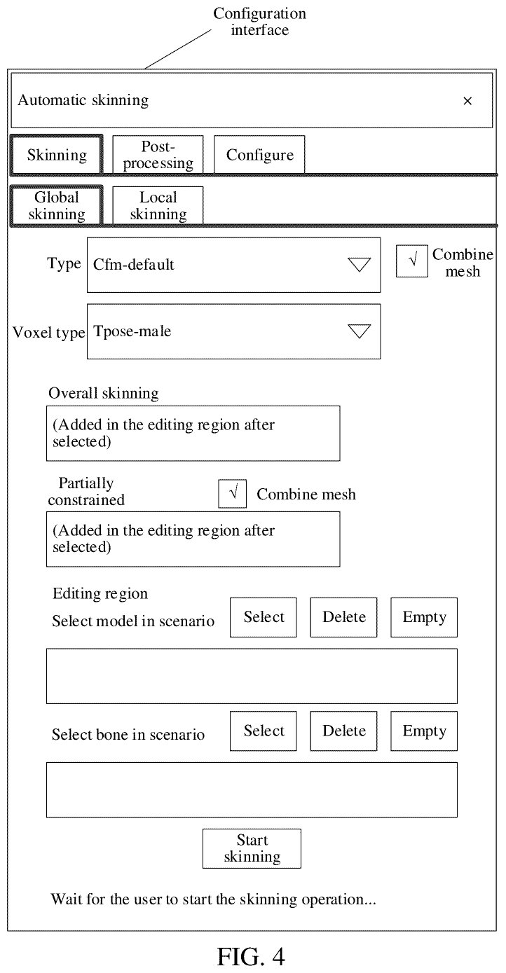

Referring to FIG. 4, FIG. 4 is a schematic interface diagram of a skinning configuration interface according to an aspect described herein. In the configuration interface shown in FIG. 4, related configuration may be performed on an entire skin (that is, global skinning) between the first object model and the second object model. For example, a clothes type (that is, a type of clothes worn by the first object model, and the second object model may be all clothes worn by the first object model or a part of clothes (for example, only an upper garment) worn by the first object model) and a voxel type (that is, a type of the first object model) may be selected. In addition, clothes needing to be entirely skinned (for example, added at model selection in the scenario, which may be adding the second object model needing to be skinned) and base bones (for example, the M base bones) affecting motion of the selected second object model may be selected at an editing region. Further, by clicking to start skinning, the processing device may be requested to perform skinning between the selected second object model and the base bone.

After configuration about a skinning-related requirement in the skinning plug-in is completed, the skinning plug-in may automatically generate a configuration file. The configuration file includes corresponding data configured by the user on the skin-related requirement in the skinning plug-in. Further, the skinning plug-in may submit the configuration file to the processing device, for the processing device to perform skinning between the first object model and the second object model.

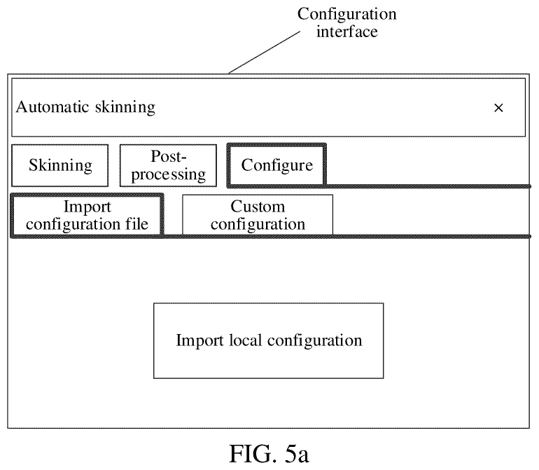

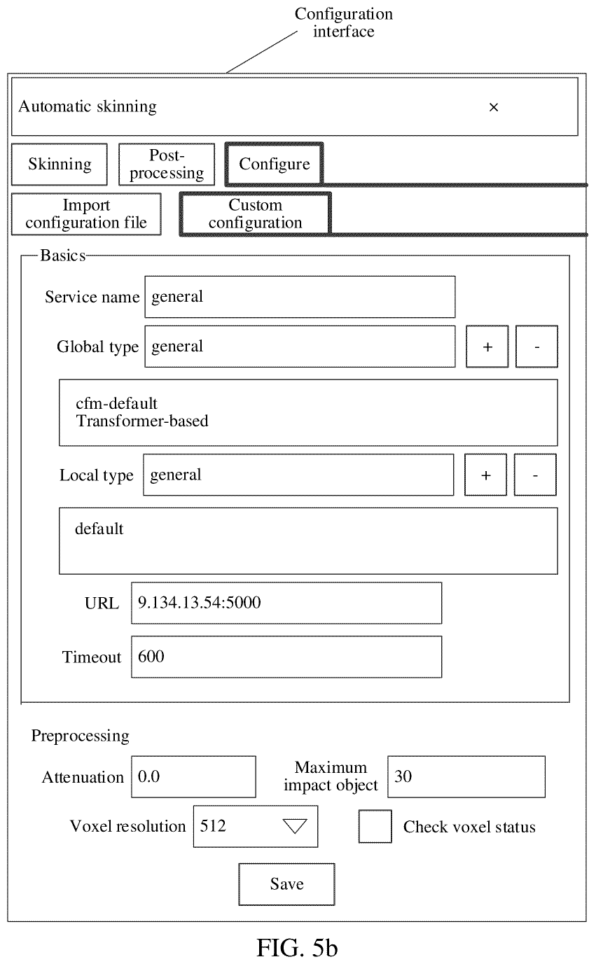

Further, referring to FIG. 5a to FIG. 5b, FIG. 5a is a schematic interface diagram 1 of a skinning configuration according to an aspect described herein, and FIG. 5b is a schematic interface diagram 2 of a skinning configuration according to an aspect described herein. The user may import, into the configuration interface shown in FIG. 5a, the configuration file generated by the skinning plug-in, or may import a pre-generated configuration file. This is not limited.

More, the configuration file may further include related information of a user-defined configuration, and the related information of the user-defined configuration may be configured on a configuration interface shown in FIG. 5b. The related information of the user-defined configuration may include a service name (for example, the first object model and the second object model on which skinning is performed may be objects in a game, and the service name may be a name of a service to which the first object model and the second object model belong), a skinning type (for example, a type of global skinning), a URL (which may be an address of a background (for example, the processing device), and may be configured for accessing a background skinning service), and the like.

Operation S104: Perform conversion processing on the first reference position and the second reference position, to generate a global prediction feature corresponding to the N motion points. The global prediction feature is configured for reflecting a global position feature between the N motion points and corresponding base bones, position features of the M base bones, and structural features of bone chains in which the base bones corresponding to the motion points are located.

In some aspects, the processing device may perform fusion embedding processing (which belongs to conversion processing) on the first reference positions of the N motion points and the second reference positions of the base bones corresponding to the N motion points, to generate a motion point global feature corresponding to the N motion points. The process may be understood as encoding (that is, fusing) the information (for example, position information) of the base bone to the information (for example, position information) of the motion point by using the second reference position of the base bone corresponding to the motion point, to obtain a global representation corresponding to the N motion points. The global representation is a motion point global feature.

Therefore, the motion point global feature may be configured for reflecting a global position feature between the N motion points and the corresponding base bones. In other words, the motion point global feature not only may include a position feature of each motion point, but also may include a feature of a relative position between each motion point and the corresponding base bone.

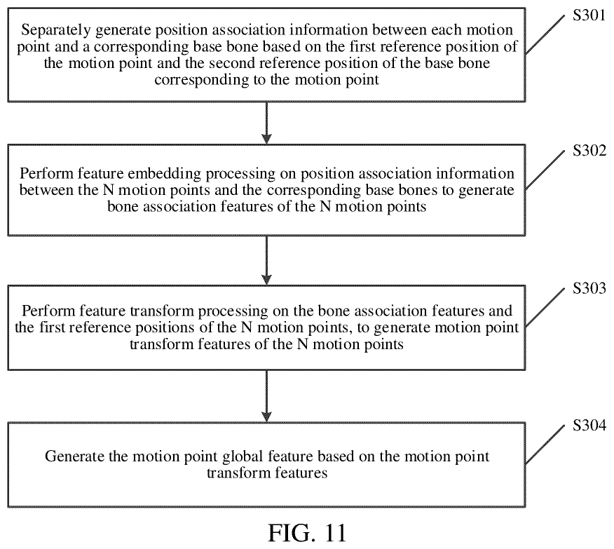

For a specific process of generating the motion point global feature, refer to related descriptions in the following aspect corresponding to FIG. 11.

In addition, the processing device may further perform feature embedding processing (also belonging to conversion processing) on the position features of the M base bones to generate bone position features of the M base bones. The bone position features may be configured for reflecting the position features of the M base bones.

The process of generating the motion point global feature interacts with the process of generating the bone position feature. For a specific process of generating the bone position feature, references may also be made to the description in the following aspect corresponding to FIG. 11.

Further, the processing device may further generate, based on bone chains on which base bones in the M base bones are located, bone chain structural features associated with the base bones corresponding to the N motion points. As the name implies, the bone chain structural features may be configured for reflecting structural features of the bone chains on which the base bones corresponding to the N motion points are located.

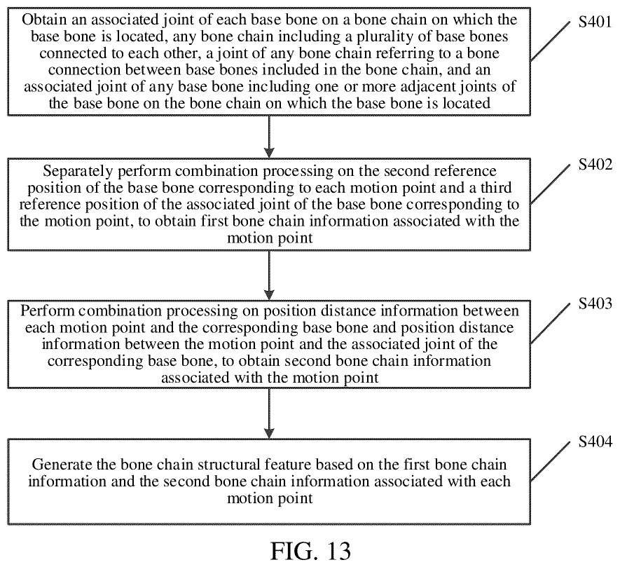

For a specific process of generating the bone chain structural feature, refer to related descriptions in the following aspect corresponding to FIG. 13.

The foregoing generated motion point global feature, bone position feature, and bone chain structural feature may all be feature matrices. Further, the processing device may perform fusion processing on the foregoing generated motion point global feature, bone position feature, and bone chain structural feature, to generate a global prediction feature. The global prediction feature is a feature configured for finally predicting motion binding parameters between N motion points and the corresponding base bones. The N motion points may correspond to the same global prediction feature.

For example, the foregoing generated motion point global feature, bone position feature, and bone chain structural feature may be concatenated (which is a feature fusion manner, and may be horizontal concatenating, and a concatenating sequence might not be limited), to generate the global prediction feature. Alternatively, performing fusion processing on the foregoing generated motion point global feature, bone position feature, and bone chain structural feature may be performing summation processing on the motion point global feature, the bone position feature, and the bone chain structural feature (for example, performing summation on feature values in same element positions (for example, same row and column positions) in the motion point global feature, the bone position feature, and the bone chain structural feature) or other processing, which may be specifically determined according to an actual application scenario.

Described herein, preferably, the motion point global feature, the bone position feature, and the bone chain structural feature may be concatenated, to obtain the global prediction feature. Such a manner may enable the motion point global feature, the bone position feature, and the bone chain structural feature to be kept and embodied in the global prediction feature to the greatest extent. The global prediction feature obtained subsequently in such a manner may also more accurately predict the motion binding parameter between the motion point and the corresponding base bone.

Therefore, the foregoing generated global prediction feature may include the motion point global feature, the bone position feature, and the bone chain structural feature. The global prediction feature may be configured for reflecting the global position feature between the N motion points and the corresponding base bones, the position features of the M base bones, and the structural features of the bone chains in which the base bones corresponding to the N motion points are located.

It can be learned that, the foregoing global prediction feature obtained described herein may include a series of complete features of position information of the N motion points, position information of the M base bones, position information between the N motion points and the corresponding base bones, and the structural features of the bone chains in which the M base bones are located (or may be referred to as association features of the bone chains in which the M base bones are located). Subsequently, global prediction can be performed on motion binding parameters between the N motion points and the corresponding base bones by using the global prediction feature.

The motion point global feature, the bone position feature, and the bone chain structural feature may all be generated by invoking a skinning network. The skinning network (which may also be referred to as a skinning model) may be a trained deep learning network configured for predicting (that is, determining) a motion binding parameter between a motion point and a corresponding base bone.

For example, the motion point global feature may be generated after fusion embedding processing is performed on the first reference positions of the N motion points and the second reference positions of the base bones corresponding to the N motion points by invoking the skinning network. The bone position feature may be generated after feature embedding processing is performed on the second reference positions of the M base bones by invoking the skinning network. The bone chain structural feature may alternatively be generated based on a bone chain on which the base bone corresponding to each motion point is located by invoking the skinning network. Further, the global prediction network may alternatively be generated after feature fusion processing is performed on the motion point global feature, the bone position feature, and the bone chain structural feature that are generated by invoking the skinning network. Feature processing operations involved in the series of processes may all be operations of performing conversion processing on the first reference position and the second reference position.

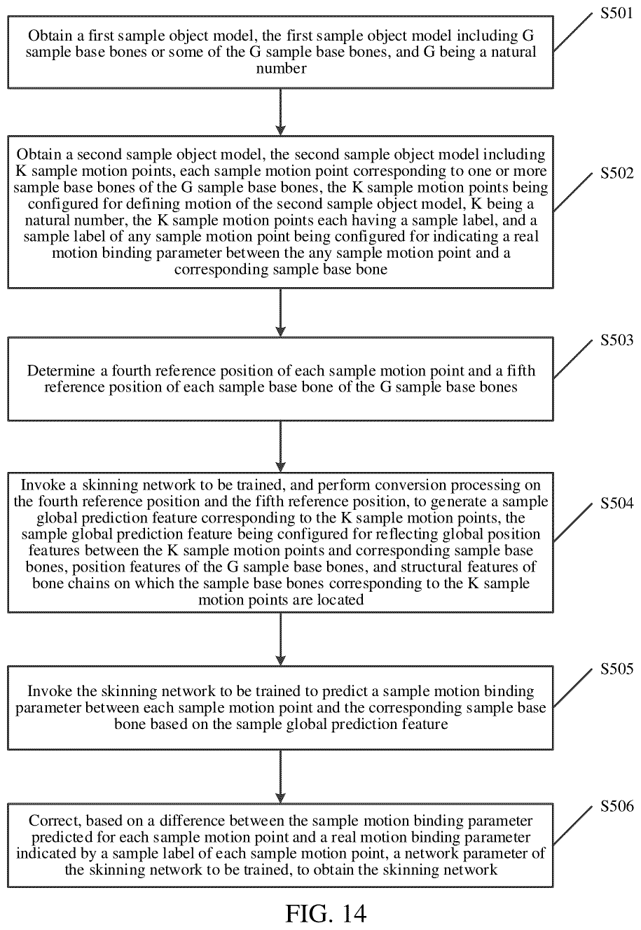

For a specific process of obtaining the skinning network through training, refer to related descriptions in the following aspect corresponding to FIG. 14. The skinning network may be a network that can be configured for performing skinning processing on the first object model and the second object model. For example, the skinning processing may be processing by which the skinning network can predict motion binding parameters between motion points of the second object model and the M base bones.

In some aspects, described herein, conversion processing might not only be performed on first reference positions of all motion points of the N motion points and second reference positions of base bones corresponding to all the motion points, to generate a global prediction feature corresponding to all the motion points. Described herein, alternatively, conversion processing may be performed on only first reference positions of some (for example, one or more) motion points in the N motion points and second reference positions of base bones corresponding to the some motion points, to generate a global prediction feature corresponding to the some motion points. In this case, by using the method provided described herein, motion binding parameters between the some motion points and the corresponding base bones may be determined. Specifically, motion binding parameters between which motion points of the second object model and corresponding base bones need to be determined may be determined according to an actual application scenario. This is not limited described herein.

Operation S105: Determine a motion binding parameter between each motion point and a corresponding base bone based on the global prediction feature. Any motion point in the N motion points is configured for moving with a corresponding base bone based on a motion binding parameter between the motion point and the corresponding base bone.

In some aspects, the processing device may determine (predict) a motion binding parameter (or referred to as a binding weight) between each motion point and a corresponding base bone by using the foregoing generated global prediction feature. Any motion point in the N motion points may be configured to move with the base bone corresponding to the motion point based on the motion binding parameter between the motion point and the corresponding base bone.

The processing device may invoke the skinning network to predict the motion binding parameter between each motion point and the corresponding base bone based on the generated global prediction feature. A motion binding parameter may be obtained through prediction between a motion point and a base bone corresponding to the motion point.

Generally, one motion point corresponds to a plurality of base bones, and only a few (for example, three or four) of motion binding parameters between the motion point and the plurality of corresponding base bones are predicted to be greater than 0 (these motion binding parameters are motion binding parameters that finally determine how the motion point moves), and other motion binding parameters are predicted to be 0 (these motion binding parameters do not affect motion of the motion point). Specifically, motion binding parameters between the motion point and which corresponding base bones being not 0 are determined by the skinning network in an adaptive learning process.

A sum (that is, a sum value) of predicted motion binding parameters between any motion point and corresponding base bones may be equal to 1.

In some aspects, the motion binding parameter between the motion point and the corresponding base bone predicted by invoking the skinning network may be used as an initial motion binding parameter. That is, the initial motion binding parameter between each motion point and the corresponding base bone may be obtained by invoking the skinning network through prediction based on the global prediction feature.

In many cases, positions of some motion points in the second object model need to be collinear. For example, if the second object model is clothes, motion points on the same clothes line of the clothes need to be collinear (that is, need to be on the same line). Therefore, described herein, the foregoing predicted initial motion binding parameter between each motion point and the corresponding base bone may be further post-processed. The post-processing may be to optimize the initial motion binding parameter between each motion point and the corresponding base bone based on a collinear optimization method for the N motion points, as described in the following content.

The processing device may calculate, by using an initial motion binding parameter predicted for each motion point, predicted motion positions of the N motion points in a plurality of target object postures (which may be a plurality of preset object postures, for example, may include all or some of object postures that can be made by the first object model) of the first object model, and one motion point may have one predicted motion position in one target object posture. A predicted motion position of one motion point in a target object posture is a position after the first object model moves from a current object posture to the target object posture by using an initial motion binding parameter predicted for each motion point. The position may be obtained through calculation by using an LBS algorithm defined in the following formula (1).

The processing device may further obtain straight line layouts formed by the N motion points in the plurality of target object postures, and the N motion points may form one straight line layout in one target object posture. A straight line layout formed by the N motion points in one target object posture is distribution of the N motion points obtained after motion points that need to be collinear in the N motion points are comparatively standardly arranged on one line when the first object model is in the target object posture.

A process of generating straight line layouts of the N motion points in a target object posture may include: First, the mesh of the second object model may include several triangles. When the first object model is in the target object posture, triangles in the mesh of the second object model that are also currently in the target object posture may be combined (that is, oblique edges are filtered out or referred to as triangle oblique edges are removed), to obtain a combined mesh. For example, two triangles having the same edge may be combined into one quadrangle. The straight line layout may be generally embodied by a quadrangle. Therefore, triangle combination may be performed on the mesh, which may also simplify a structure of the mesh, reduce difficulty in generating the straight line layout and reduce a calculation amount of generating the straight line layout. In the foregoing process, only some edges in the mesh are eliminated, but motion points in the mesh are not eliminated, and all the motion points are reserved.

Further, a half-edge structure may be established for the combined mesh (edges in the combined mesh have directions, that is, one edge may have an outgoing edge and/or an incoming edge, and two connected motion points in the mesh may form one edge), to traverse motion points (that is, vertexes) that need to be collinear in the combined mesh. For example, for an edge, a traversed edge whose angle is the smallest and tends to be 0 (for example, less than an angle threshold, where the angle threshold is a value tending to 0) may be used as an edge that the edge needs to be collinear.

Further, motion points on edges that need to be collinear may be used as motion points that need to be collinear, and smoothing processing may be performed on positions of the motion points that need to be collinear, so that the motion points that need to be collinear are located on a smoother line, and a straight line layout of the N motion points in such a target object posture may be generated.

Therefore, the processing device may further obtain target posture positions of the N motion points in the various target object postures based on the straight line layout formed by the N motion points in the foregoing various target object postures, that is, a position of a motion point determined by means of the straight line layout may be referred to as a target posture position, and one motion point may have one target posture position in one target object posture.

Further, the processing device may optimize initial motion binding parameters between the N motion points and the corresponding base bones based on differences between the predicted motion positions of the N motion points in the foregoing plurality of target object postures and target posture positions of the N motion points in the plurality of target object postures, and further use optimized initial motion binding parameter as final motion binding parameters between the motion points and the corresponding base bones.

The process of performing optimization processing on the initial motion binding parameters between the N motion points and the corresponding base bones based on differences between the predicted motion positions of the N motion points in the plurality of target object postures and target posture positions of the N motion points in the plurality of target object postures may include: The processing device may calculate a corresponding loss function (which may be referred to as a target loss function) by using predicted motion positions of the N motion points in the foregoing plurality of target object postures and target posture positions of the N motion points in the plurality of target object postures. The loss function may be an L2-loss (a square loss function) or a mean square error loss (MSE, which is a loss function) between the predicted motion positions of the N motion points in the foregoing plurality of target object postures and the target posture positions of the N motion points in the plurality of target object postures. The loss function may be configured for reflecting errors of the predicted motion positions of the N motion points in the foregoing plurality of target object postures relative to the target posture positions of the N motion points in the plurality of target object postures.

Therefore, the processing device may adjust (that is, optimize) the initial motion binding parameter between each motion point and the corresponding base bone by using the target loss function, so that the target loss function tends to a minimum value (for example, tends to 0). By making the target loss function tend to the minimum value, the predicted motion positions of the N motion points in the foregoing plurality of target object postures entirely get close to (that is, approach to) the target posture positions of the N motion points in the plurality of target object postures.

Therefore, after the initial motion binding parameter between each motion point and the corresponding base bone is optimized by using the foregoing process, accuracy of a finally obtained motion binding parameter between each motion point and the corresponding base bone can be improved. By using the accurate motion binding parameter, motion points in the N motion points of the second object model that need to be collinear are more normally collinear after the first object model moves, thereby achieving more accurate skinning between the first object model and the second object model.

In some aspects, in addition to the foregoing collinear optimization manner, the manner of performing post-processing on the motion binding parameter obtained through prediction may further include other additional processing, such as any feasible processing such as vertex stitching processing, patch penetration processing, and weight constraint processing at a seam. The post-processing manner may be randomly selected according to an actual application requirement.

Vertex stitching may refer to attaching another object model (for example, a flower or any other object) to the second object model to move. Therefore, a vertex weight of the another object model (that is, a binding weight between a motion point of the another object model and a base bone of the first object model) may be set to be consistent with a vertex weight of the another object model to be attached to a local portion of the second object model (that is, a position to which the another object model needs to be attached) (that is, a binding weight between the motion point of the second object model at the local portion and the corresponding base bone).

Because the second object model may have a plurality of overlapped layers (for example, a plurality of overlapped layers of clothes, which may be referred to as a plurality of overlapped layers of local objects), patch penetration processing may refer to setting weights of overlapped vertexes in the plurality of overlapped layers of the second object model (that is, a weight between a vertex and a corresponding base bone) to be consistent.

The weight constraint processing at a seam may refer to setting a vertex weight of a motion point at a local portion (for example, the neckerchief of the second object model) at which the second object model completely follows a local portion (for example, the neck of the first object model) of the first object model to perform attaching motion, to a vertex weight such that a position at the local portion (that is, the neckerchief) of the second object model is the same as a position at the local portion (that is, the neck) of the first object model.

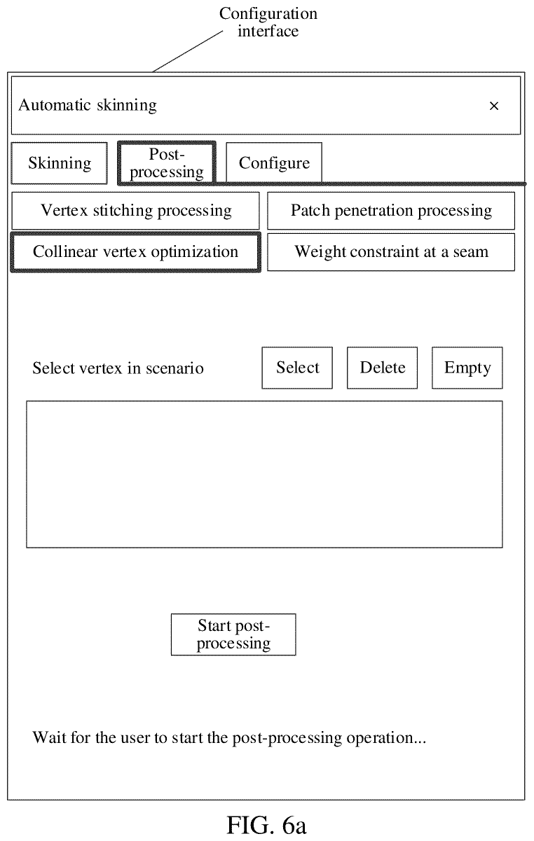

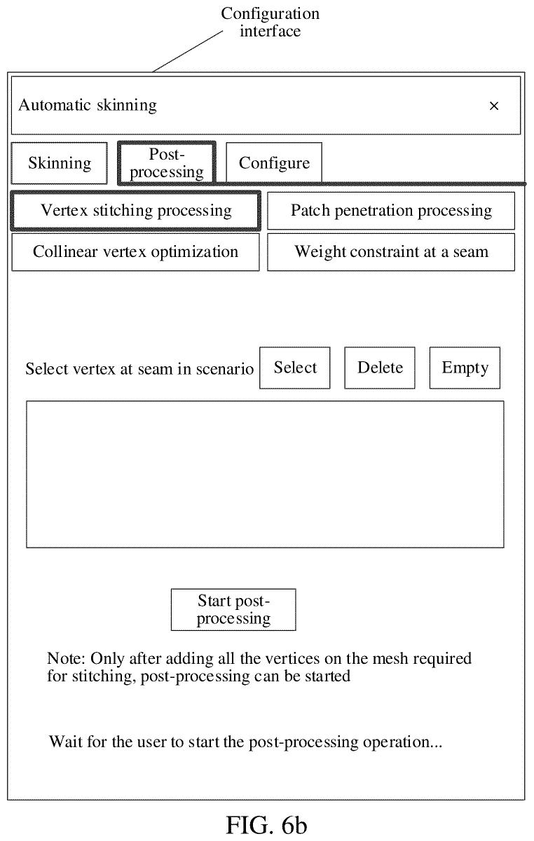

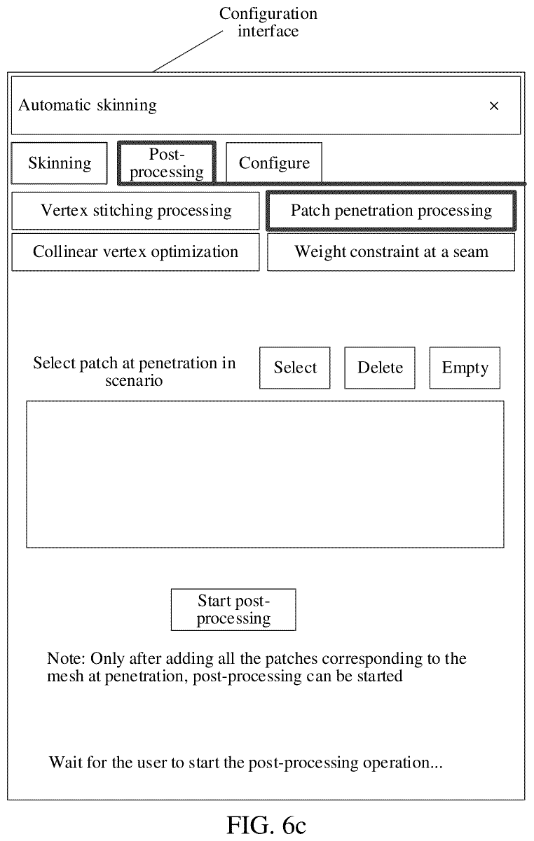

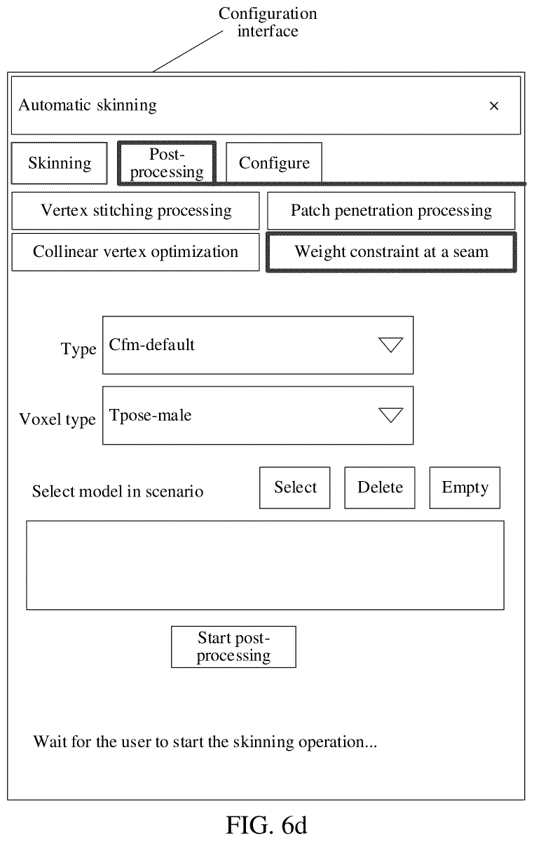

Referring to FIG. 6a to FIG. 6d, FIG. 6a is a schematic interface diagram 1 of a post-processing configuration interface according to an aspect described herein, FIG. 6b is a schematic interface diagram 2 of a post-processing configuration interface according to an aspect described herein, FIG. 6c is a schematic interface diagram 3 of a post-processing configuration interface according to an aspect described herein, and FIG. 6d is a schematic interface diagram 4 of a post-processing configuration interface according to an aspect described herein. The configuration interface shown in FIG. 6a to FIG. 6d may also be an interface in the foregoing skinning plug-in. Specifically, the user may select, in the configuration interface shown in FIG. 6a, a vertex (that is, a motion point) on which collinear vertex optimization needs to be performed, may select, in the configuration interface shown in FIG. 6b, a vertex on which vertex stitching needs to be performed, may select, in the configuration interface shown in FIG. 6c, a patch (for example, a plurality of layers of overlapped clothes) on which patch penetration processing needs to be performed, and may select, in the configuration interface shown in FIG. 6d, clothes (for example, a neckerchief) on which weight constraint processing at a seam needs to be performed.

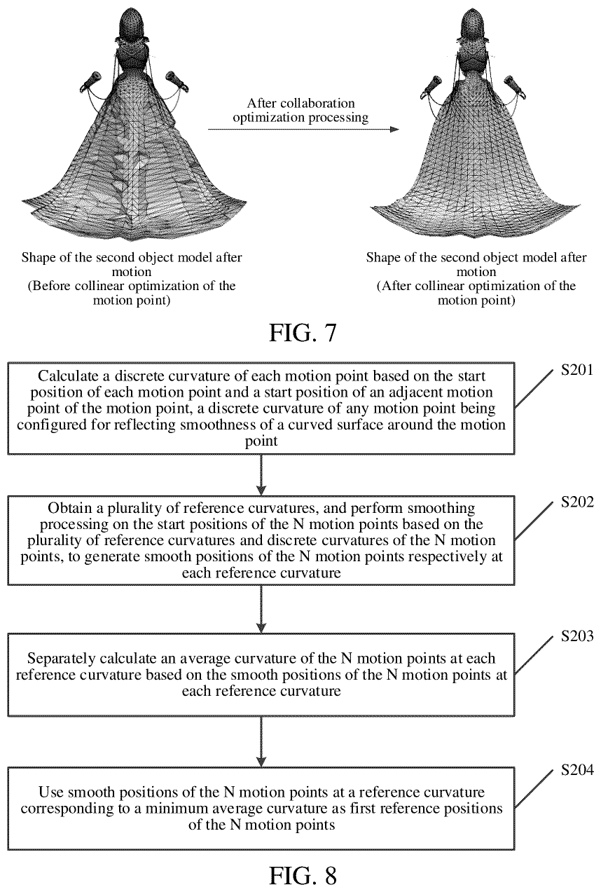

Referring to FIG. 7, FIG. 7 is a schematic diagram of a post-processing effect according to an aspect described herein. As shown in FIG. 7, in some scenarios, if collinear optimization processing is not performed on a motion binding parameter between a predicted motion point of the second object model and a corresponding base bone, after the second object model moves based on the predicted motion binding parameter, lines of the second object model may be cluttered, and after collinear optimization processing is performed on a motion binding parameter between a predicted motion point of the second object model and a corresponding base bone, lines of the second object model are regularly arranged.

After the motion binding parameter between each motion point and the corresponding base bone is obtained through prediction, when the base bone corresponding to the motion point moves, the motion point can move with the corresponding base bone based on the motion binding parameter between the motion point and the corresponding base bone. Described herein, an LBS algorithm may be configured for enabling motion of the base bone to drive the motion point to move, as shown in the following formula:

$$\overline{{p}_{l}} = {\sum }_{j = 1}^{J} {w}_{ij} {T}_{j} {p}_{i} \qquad ( 1 )$$

where i represents an ith motion point in the N motion points, i may be a positive integer less than or equal to N, that is, the ith motion point may be any motion point in the N motion points. pᵢ may be a start position of the ith motion point, j represents a jth base bone corresponding to the ith motion point, j is a positive integer less than or equal to J, and J may be a total quantity of base bones corresponding to the ith motion point. Tⱼ may be a motion parameter of the jth base bone. The motion parameter may be a translational and rotational motion matrix of the jth base bone. That is, the motion parameter is configured for indicating how the jth base bone needs to move, for example, a translation distance and a rotation angle in which direction. wᵢⱼ is a motion binding parameter between the ith motion point and the corresponding jth base bone, that is, a control weight of the jth base bone for the ith motion point. p̅ᵢ̅ is a position that the ith motion point needs to reach after moving with motion of the corresponding base bone.

By setting an object posture to which the first object model needs to move, Tⱼ may be automatically determined. If the first object model needs to move from a static object posture (for example, a standing object posture) to a jumping object posture, Tⱼ is a motion parameter of the jth base bone in the process in which the first object model moves from the standing object posture to the jumping object posture, for example, a distance by which the jth base bone needs to be translated and an angle by which the jth base bone needs to be rotated when the first object model moves from the standing object posture to the jumping object posture.

The parameters in the foregoing formula (1) may be obtained based on that the first object model is in a static object posture (that is, a standard object posture, also referred to as a starting object posture). If the first object model performs a plurality of times of posture transform (that is, a plurality of times of motion) in a process, the parameters in the formula (1) may be obtained by continuously superimposing related parameters of transformed postures based on the static object posture of the first object model. In other words, the parameters in the foregoing formula (1) may be parameters for moving the first object model to a desired posture based on that the first object model is in a static object posture (that is, a standard object posture, also referred to as a starting object posture).

The foregoing process describes an overall process of updating positions of the N motion points based on the motion binding parameters between the M base bones and the N motion points with motion of the M base bones, so that the N motion points respectively move with the corresponding base bones. The foregoing process is a process of performing overall skinning on the first object model and the second object model. It can be known from the above that described herein, when the motion parameter of the motion point corresponding to the base bone is known, the motion position of the motion point can be determined by using the motion binding parameter between the motion point and the corresponding base bone. In other words, when the motion parameter of the motion point corresponding to the base bone is known, the base bone corresponding to the motion point can drive the motion point to perform corresponding motion by using the motion binding parameter between the motion point and the corresponding base bone.

Described herein, a skinning network obtained by means of deep learning can be configured for quickly and accurately predicting a motion binding parameter between a motion point and a corresponding base bone, thereby reducing labor overheads of manually establishing, by an artist, the motion binding parameter between the motion point and the corresponding base bone.

Described herein, the first object model and the second object model may be obtained. The first object model may include the M base bones or some of the M base bones. The second object model may include the N motion points. Each motion point may correspond to one or more base bones of the M base bones. The N motion points may be configured for defining motion of the second object model. Therefore, described herein, feature embedding processing may be performed on the first reference positions of the N motion points and the second reference positions of the M bones, to generate the global prediction feature corresponding to the N motion points. The global prediction feature may be configured for reflecting a global position feature between the N motion points and corresponding base bones, position features of the M base bones, and structural features of bone chains in which the base bones corresponding to the N motion points are located. Therefore, described herein, a motion binding parameter between each motion point and a corresponding base bone may be determined based on the global prediction feature. Any motion point in the N motion points may move with a corresponding base bone based on a motion binding parameter between the motion point and the corresponding base bone. It can be learned that, in the method provided described herein, feature embedding processing may be performed on the first reference position of each motion point in the first object model and the second reference position of each motion point and the corresponding base bone in the second object model, to obtain the global prediction feature corresponding to the N motion points. The global prediction feature may include a plurality of features, such as a global position feature between a motion point and a corresponding base bone, position features of M bones, and structural features of bone chains in which the M bones are located. Subsequently, a motion binding parameter between each motion point and a corresponding base bone can be quickly and accurately determined by using the global prediction feature. Any motion point can accurately move with the corresponding base bone based on the motion binding parameter between the motion point and the corresponding base bone.

Referring to FIG. 8, FIG. 8 is a schematic flowchart of a position smoothing method according to an aspect described herein. As shown in FIG. 8, the method may include:

Operation S201: Calculate a discrete curvature of each motion point based on the start position of each motion point and a start position of an adjacent motion point of the motion point. A discrete curvature of any motion point is configured for reflecting smoothness of a curved surface around the motion point.

In some aspects, the N motion points each have a start position. The start positions are positions of the N motion points of the second object model when the first object model carries the second object model in a static posture (for example, a static standard posture).

The processing device may obtain an adjacent motion point (which may also be referred to as an adjacent vertex or a neighboring vertex) of each motion point in the N motion points, and an adjacent motion point of one motion point may include each motion point that is in a mesh of the second object model and that is directly connected to the motion point (that is, has a connection relationship).

The processing device may calculate a discrete curvature (which may also be referred to as a discrete average curvature) of any motion point by using a start position of the any motion point and a start position of an adjacent motion point of the any motion point. The discrete curvature may be configured for reflecting a smoothness degree (or referred to as a smooth curvature degree) of a surrounding curved surface (for example, a curved surface of a surrounding mesh) of the any motion point. A larger discrete curvature indicates a more unsmooth surrounding curve of the any motion point. Otherwise, a smaller discrete curvature indicates a smoother surrounding curve of the any motion point. One motion point has one discrete curvature, and the discrete curvatures of the N motion points can be obtained by using the foregoing process.

The start position of the motion point may be a position of three dimensions in a three-dimensional coordinate system (for example, may include an x-axis, a y-axis, and a z-axis), and the discrete curvature of the motion point may be calculated by substituting a start position of any one of the motion points and a start position of an adjacent motion point of the motion point into a mathematical formula configured for calculating the discrete curvature.

Operation S202: Obtain a plurality of reference curvatures, and perform smoothing processing on the start positions of the N motion points based on the plurality of reference curvatures and discrete curvatures of the N motion points, to generate smooth positions of the N motion points respectively at each reference curvature.

In some aspects, described herein, smoothing processing on the start positions of the N motion points may be implemented by using the reference curvature. Described herein, a target of performing smoothing processing on the start positions of the motion points may be to moderately smooth and collapse a detailed area having wrinkles and a fluffy shape in the second object model (such as clothes), and keep an original shape of a region having a relatively smooth curved surface in the second object model as much as possible without modification.

Therefore, described herein, when smoothing processing is performed on the start positions of the N motion points by using the reference curvature, smoothing processing may be performed on a start position of a motion point that is in the N motion points and whose discrete curvature is greater than or equal to the reference curvature (that is, a motion point whose surrounding curved surface is not very smooth), and a start position of a motion point that is in the N motion points and whose discrete curvature is less than the reference curvature (that is, a motion point whose surrounding curved surface is relatively smooth) remains the same, and smoothing processing is not performed.

Based on this, because shapes and styles of different second object models may vary greatly (for example, shapes and styles of a large quantity of complex clothes that are shaped and designed may vary greatly), it is difficult to adapt to all shapes of clothes by using one given reference curvature. Therefore, described herein, smoothing processing may be sequentially performed on the start position of the motion point of the second object model by using a set formed by a group of set reference curvatures, so that a most appropriate reference curvature can be adaptively selected for a particular second object model, to perform smoothing processing on the start position of the motion point of the second object model by using the most appropriate reference curvature.

Therefore, the processing device may obtain a plurality of reference curvatures, the plurality of reference curvatures may be a plurality of reference curvatures having different values, and a quantity of and values of the plurality of reference curvatures may be randomly set according to an actual application scenario. For example, a plurality of suitable curvatures having uniform value distribution (for example, the values are in an equal sequence) are set as the plurality of reference curvatures, which is not limited.

Then, the processing device may perform smoothing processing on the start positions of the N motion points by using the plurality of reference curvatures and the discrete curvatures of the N motion points, to generate smooth positions of the N motion points respectively at each reference curvature. One motion point has one smooth position at one reference curvature.

Any one of the plurality of reference curvatures may be referred to as a target reference curvature. The following describes, by using an example, a process of performing smoothing processing on the start positions of the N motion points based on the target reference curvature and the discrete curvatures of the N motion points, to obtain smooth positions of the motion points at the target reference curvature, as described in the following content.

The processing device may use a motion point that is in the N motion points and whose discrete curvature is greater than the target reference curvature as a motion point that needs to be adjusted (which may be referred to as a motion point that needs to be adjusted). Further, the processing device may perform smoothing processing on a start position of the motion point that needs to be adjusted, to generate a smoothed start position of the motion point that needs to be adjusted. A start position of a motion point other than the motion point that needs to be adjusted in the N motion points is not to be smoothed, and remains unchanged.

Further, the processing device may use the start position of the motion point other than the motion point that needs to be adjusted in the N motion points and the smoothed start position of the motion point that needs to be adjusted as smooth positions of the N motion points at the target reference curvature, that is, one motion point has one smooth position at the target reference curvature. The smooth position may be the start position of the motion point, or may be the smoothed start position of the motion point.

In some aspects, described herein, a Laplace smoothing algorithm may be configured for smoothening the start position of the motion point that needs to be adjusted. The idea of the Laplace smoothing algorithm is to continuously adjust a position of a vertex based on a position relationship of a neighboring vertex in a mesh in a plurality of iteration manners, to improve a shape and quality of the mesh, as shown in the following formula.

$${P}^{( d )} = {P}^{( d - 1 )} - λ {LP}^{( d - 1 )} \qquad ( 2 )$$

$$L ( {p}_{s} ) = \frac{1}{{\sum }_{c ϵ {N}_{s}} {w}_{sc}} ( {\sum }_{c ϵ {N}_{s}} {w}_{sc} {p}_{c} ) - {p}_{s} \qquad ( 3 )$$

Any one of the motion points that need to be adjusted may be a motion point s, and d represents a quantity of times of performing iterative adjustment on a position of the motion point s (the quantity of times may be set according to an actual application scenario, and may be performing iterative update on a start position of the motion point s). pₛ is an element in P^{(d-1)},pₛ represents a position of the motion point s after d-1 times of iterative update, P^{(d-1)} includes positions after performing d-1 times of iterative update on start positions of all motion points that need to be adjusted, and p^{(d)} includes positions after performing d times of iterative update on the start positions of all the motion points that need to be adjusted. λ is a hyper parameter, and a value range may be within [0, 1]. A larger value of λ means that a position of a surrounding neighboring vertex of a motion point (or may be an adjacent motion point) has greater impact on a position update (that is, smoothing) of the motion point.

L is a Laplace matrix, and determines an update direction of a position of each motion point that needs to be adjusted. Pc represents a position after performing d-1 times of iterative update on a position of any neighboring motion point c (which may be an adjacent motion point, or may be referred to as a neighboring vertex) of the motion point s. That is, c represents any neighboring motion point of the motion point s; and Nₛ is a set of neighboring motion points of the motion point s. w_{sc} is a weight of impact of the neighboring motion point c on position update of the motion point s in a Laplace smoothing process, and a larger weight indicates larger impact of the neighboring motion point c on position update of the motion point s. L (pₛ) is included in the Laplace matrix L, and L (pₛ) represents a Laplace vector representation of the motion point s.

Therefore, by using the foregoing described principle, after smoothing processing is separately performed on the start positions of the N motion points by using each reference curvature, the smooth positions of the N motion points at each reference curvature can be obtained.

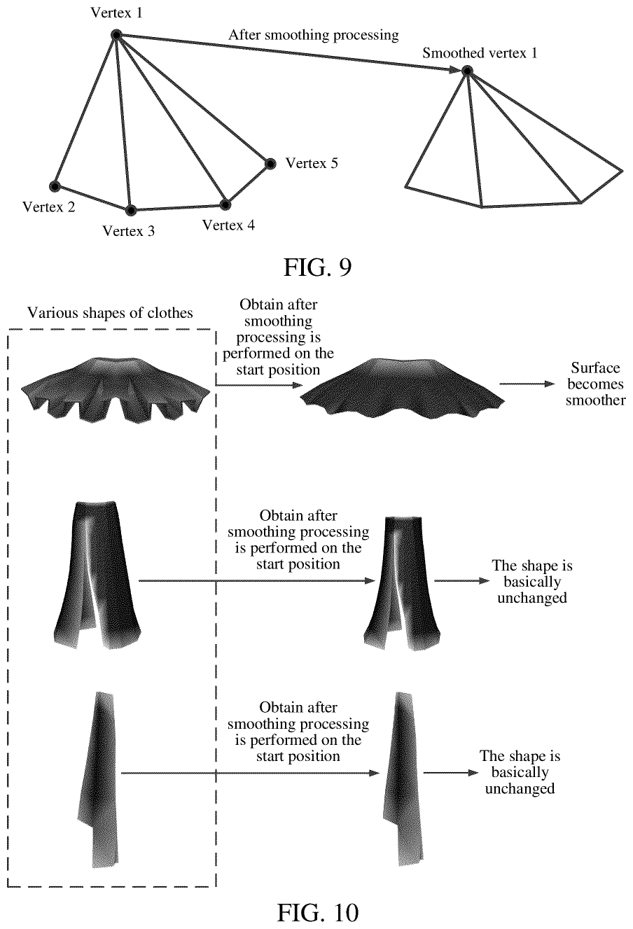

Referring to FIG. 9, FIG. 9 is a schematic diagram of a scenario of position smoothing processing according to an aspect described herein. As shown in FIG. 9, a vertex 1 may be any motion point of the second object model, and a vertex 2 to a vertex 5 may be adjacent vertexes (that is, adjacent motion points) of the vertex 1. Therefore, after smoothing processing is performed on a start position of the vertex 1 by using start positions of the vertex 2 to the vertex 5, a smoothed vertex 1 may be obtained, and a position of the smoothed vertex 1 may become more collapsible compared with the position of the vertex 1 before smoothing.

Referring to FIG. 10, FIG. 10 is a schematic diagram of an effect of smoothing a second object model according to an aspect described herein. By using the foregoing method described herein for adaptively selecting a reference curvature based on the shape of the second object model (that is, the shape of the clothes), after smoothing processing is performed on the first skirt having a relatively large quantity of wrinkles in FIG. 10, the curved surface of the skirt may be made to be smoother. After the second skirt having a relatively smooth open curved surface and the third waistband of a thin-layer structure in FIG. 10 are smoothed, the skirt and the waistband basically keep the original shape of the clothes. Therefore, by using the foregoing method described herein, the clothes can be moderately smoothed, without excessively large deformation of the clothes caused after smoothing processing is performed on the clothes.

Operation S203: Separately calculate an average curvature of the N motion points at each reference curvature based on the smooth positions of the N motion points at each reference curvature.

In some aspects, the processing device may separately calculate the average curvature of the N motion points at each reference curvature by using the smooth positions of the N motion points at each reference curvature.

Herein, still, a process of calculating an average curvature of the N motion points at the target reference curvature is used as an example for description, and the following content is described.

The processing device may calculate a discrete curvature of any motion point at the target reference curvature based on a smooth position of the motion point at the target reference curvature and a smooth position of an adjacent motion point of the motion point at the target reference curvature (a calculation manner is the same as the foregoing manner of calculating the discrete curvature by using the start position). In this manner, the discrete curvature of each motion point at the target reference curvature can be calculated.

Further, the processing device may calculate an average value of a discrete curvature of each motion point respectively at the target reference curvature, to obtain the average curvature of the N motion points at the target reference curvature.

By using the foregoing principle, the processing device may calculate the average curvature of the N motion points at each reference curvature, and an average curvature of the N motion points at one reference curvature may be referred to as an average curvature corresponding to the reference curvature.

Operation S204: Use smooth positions of the N motion points at a reference curvature corresponding to a minimum average curvature as first reference positions of the N motion points.

In some aspects, the processing device may use smooth positions of the N motion points at a reference curvature corresponding to a smallest average curvature (that is, the smoothed start positions of the N motion points entirely reach the smoothest reference curvature) as final first reference positions of the N motion points.

In other words, the processing device may use the reference curvature corresponding to the minimum average curvature as the reference curvature finally configured for performing smoothing processing on the start positions of the N motion points. The processing device may use the smooth positions of the N motion points respectively at the reference curvature as the first reference positions of the N motion points.

By means of the foregoing process, smoothing processing may be respectively performed on the start positions of the N motion points by using the plurality of reference curvatures, and further, a reference curvature (that is, a reference curvature corresponding to the smallest average curvature) finally configured for performing smoothing processing on the N motion points may be adaptively selected from the plurality of reference curvature by using a result of performing smoothing processing on the start positions of the N motion points, to obtain the first reference positions in which overall optimal smoothing processing is finally performed on the start positions of the N motion points. Subsequently, the motion binding parameters between the N motion points and the corresponding base bones can be predicted more accurately by using the first reference positions obtained by performing smoothing processing on the start positions of the N motion points.

Referring to FIG. 11, FIG. 11 is a schematic flowchart of a feature generation method according to an aspect described herein. The aspect corresponding to FIG. 11 mainly describes a process of generating the motion point global feature. However, because the process of generating the motion point global feature and the process of generating the bone position features of the M base bones interact with each other, the following process further describes the process of generating the bone position features of the M base bones (specifically, described in the following operation S304). As shown in FIG. 11, the method may include:

Operation S301: Separately generate position association information between each motion point and a corresponding base bone based on the first reference position of the motion point and the second reference position of the base bone corresponding to the motion point.

In some aspects, the processing device may separately generate position association information between each motion point and the corresponding base bone by using the first reference position of each motion point and the second reference position of the base bone corresponding to each motion point. There may be one piece of position association information between one motion point and one base bone corresponding to the motion point.

Any motion point of the N motion points may be a target motion point, and position association information between the target motion point and any base bone corresponding to the target motion point may include at least one of the following: relative position information between the target motion point and the base bone, an absolute distance between the target motion point and the base bone, and a shortest path distance between the target motion point and the base bone.

The relative position information may be a difference between a first reference position of the target motion point and a corresponding second reference position of the base bone. Because both the start position of the motion point and the first reference position may be three-dimensional, the relative position information may also be three-dimensional, and the relative position information may be configured for reflecting a relative position between the target motion point and the corresponding base bone.

The absolute distance may be a Euclidean distance between the first reference position of the target motion point and the corresponding second reference position of the base bone. The Euclidean distance may be one-dimensional, and the Euclidean distance may be configured for reflecting a real distance between the target motion point and the corresponding base bone in three-dimensional space.

The shortest path distance may be a geodesic distance between the target motion point and the corresponding base bone, the geodesic distance may be a shortest distance between the target motion point and the corresponding base bone, and the geodesic distance may also be one-dimensional.

Therefore, there may be a piece of 5-dimensional position association information between the target motion point and the corresponding base bone. If a quantity of base bones corresponding to each motion point is R, and R is a positive integer, a total dimension of position association information between the N motion points and the corresponding base bones may be represented as (N, R, 5).

Operation S302: Perform feature embedding processing on position association information between the N motion points and the corresponding base bones to generate bone association features of the N motion points.

In some aspects, the processing device may invoke the foregoing skinning network to perform feature embedding on position association information (a total of (N, R, 5) dimensions) between the N motion points and the corresponding base bones, to encode information (such as position information) about a base bone corresponding to each motion point into information about each motion point, to generate the bone association features of the N motion points, that is, features obtained by performing feature embedding on the position association information (a total of (N, R, 5) dimensions) between the N motion points and the corresponding base bones may be referred to as bone association features.

A finally obtained dimension of the bone association feature may be (N, 64). That is, position association information between a motion point and a corresponding base bone is embedded, to finally obtain a 64-dimensional feature. Each motion point may correspond to a 64-dimensional (actually, may also be set to another dimension, which is not limited) feature in the bone association feature.

Operation S303: Perform feature transform processing on the bone association features and the first reference positions of the N motion points, to generate motion point transform features of the N motion points.

In some aspects, the processing device may obtain normal information of each motion point in a standard coordinate system (for example, a world coordinate system, including three dimensions in total of an x-axis, a y-axis, and a z-axis), or the normal information may be three-dimensional.

Further, the processing device may combine the first reference position (3-dimensional) of each motion point and the normal information (3-dimensional) of each motion point, to obtain basic features of the N motion points. A dimension of the basic feature may be (N, 6), that is, one motion point corresponds to a 6-dimensional feature in the basic feature, and the 6-dimensional feature may include the first reference position of the motion point and the normal information of the motion point.

Further, the processing device may perform fusion processing on the bone association features and the basic features, to generate initial representation features of the N motion points. That is, features obtained by performing fusion processing on the bone association features and the basic features may be referred to as initial representation features (the initial representation features may be a feature matrix) of the N motion points. In some aspects, fusion processing may be concatenating processing, or may be other processing, and may be specifically determined according to an actual application scenario. A dimension of the initial representation feature may be (N, 70), that is, one motion point may correspond to one 70-dimensional feature in the initial representation feature.

Further, the processing device may perform feature transform processing on the foregoing initial representation feature (which may mainly be stretching and rotating the initial representation feature), to generate motion point transform features of the N motion points. That is, a feature obtained after performing feature transform processing on the initial representation feature may be referred to as a motion point transform feature (which may be a feature matrix).

In some aspects, a dimension of the motion point transform feature may also be (N, 70), that is, one motion point may correspond to one 70-dimensional feature in the motion point transform feature, and one 70-dimensional feature of one motion point in the motion point transform feature may be referred to as a transform feature of the motion point. In other words, the motion point transform feature may include a transform feature of each motion point.

The feature transform processing is performed on the initial representation feature, to transform the posture of the first object model (for example, transform from a feature of a standing posture to a feature of a jumping posture). This manner can increase precision of the feature, so that the skinning network can adapt to a plurality of transformed features, thereby making the skinning network have higher robustness to the posture of the first object model.

Operation S304: Generate the motion point global feature based on the motion point transform features.

In some aspects, the processing device may obtain a neighboring feature of each motion point, to perform information exchange between each motion point and a corresponding neighborhood motion point, as described in the following content.

Any one of the N motion points may be referred to as a target motion point. A process of obtaining a neighboring feature of the target motion point is used as an example for specific description below: The processing device may select a plurality of neighboring motion points from the N motion points for the target motion point in a plurality of neighbor selection manners (which may be a plurality of preset manners), so that a plurality of neighboring features of the target motion point can be subsequently obtained. A neighboring motion point of the target motion point may be obtained by using a neighbor selection manner.

For example, the plurality of manners of selecting a neighboring motion point may include at least two of the following:

A first manner of selecting a neighboring motion point may be as follows: The target motion point may have several connected motion points in the mesh. Therefore, a plurality of motion points (which may be adjacent motion points belonging to the target motion point) may be selected (for example, randomly selected) from the several motion points connected to the target motion point, and used as neighboring motion points of the target motion point.

A second manner of selecting a neighboring motion point may be as follows: A plurality (which may be a specified quantity) of motion points having a smallest difference between the transform feature and the transform feature of the target motion point are used as neighboring motion points of the target motion point. In some aspects, a transform feature of a motion point may be represented as a feature vector, and a difference between transform features of different motion points may be reflected by a vector distance. A larger vector distance between different transform features indicates a larger difference between different transform features.

A third manner of selecting a neighboring motion point may be as follows: The N motion points may be clustered, so that motion points clustered to the same category are used as neighboring motion points of each other. In some aspects, a manner of clustering the N motion points may be as follows: Clustering may be performed based on a distance (for example, a geodesic distance) between each motion point and each base bone. For example, a plurality of motion points (which may be a specified quantity) closest to the same base bone may be clustered to the same category, to obtain categories clustered based on the base bones. Different categories may include some same motion points. Therefore, other motion points in a category of a motion point may be all used as neighboring motion points of the motion point.

The processing device may separately perform feature embedding processing on the transform feature of the target motion point and a transform feature of each neighboring motion point of the target motion point, to generate a plurality of neighbor association features of the target motion point, where the plurality of neighbor association features belongs to neighboring features of the target motion point. In other words, feature embedding processing is performed on the transform feature of the target motion point and a transform feature of a neighboring motion point of the target motion point, to generate a neighbor association feature of the target motion point.

A process of performing feature embedding processing on the transform feature of the target motion point and a transform feature of one neighboring motion point of the target motion point, to generate one neighbor association feature of the target motion point may include the following: The processing device may invoke the skinning network to concatenate the transform feature of the target motion point and the transform feature of the neighboring motion point of the target motion point, to obtain a concatenated neighboring feature. Further, the processing device may invoke the skinning network to perform feature embedding on the concatenated neighboring feature, to generate the neighbor association feature of the target motion point.

By using the same principle described above, a plurality of types of neighbor association features of each motion point may be obtained, that is, one motion point may have a plurality of types of neighbor association features. The processing device may perform fusion processing on all neighbor association features of the N motion points, to generate target neighboring features of the N motion points. The target neighboring features include the neighboring features of the N motion points. In some aspects, fusion processing may be concatenating processing, or may be another processing, and may be specifically determined according to an actual application scenario.

Further, the processing device may perform feature reforming processing (also referred to as feature transform processing) on the target neighboring feature, to generate the motion point global feature.

A process of performing feature reforming processing on the target neighboring feature, to generate a motion point global feature may include the following: The processing device may further obtain the motion point interaction feature. The motion point interaction feature may be obtained after feature interaction processing is performed on position features of the N motion points (for example, features of the first reference positions of the N motion points and the relative position features between the N motion points and the corresponding base bones) and position features of the base bones corresponding to the N motion points (for example, features of reference positions of the M base bones).

The processing device may perform fusion processing on the motion point interaction feature and the target neighboring feature, to generate the target motion point feature. That is, a feature obtained after the motion point interaction feature and the target neighboring feature are fused may be referred to as the target motion point feature. Fusion processing may be concatenating processing or other processing, and may be specifically determined according to an actual application scenario. Further, the processing device may perform feature reforming processing on the target motion point feature, to generate a motion point global feature.

The motion point interaction feature may be generated in an interaction process of the process of generating the motion point global feature and the process of generating the bone position feature. The process of generating the motion point interaction feature is described in the following content.

The processing device may select a neighbor bone of each base bone from the M base bones. In some aspects, the M base bones may form a bone topology. The bone topology reflects a structural relationship (for example, a connection relationship) between the M base bones. The processing device may select a neighbor bone of each base bone based on the bone topology. For example, a plurality of other base bones closest to a base bone may be used as neighbor bones of the base bone by using the bone topology.

Further, the processing device may separately perform concatenating processing on the second reference position of each base bone and a second reference position of the neighbor bone of the base bone to generate concatenating position information of the base bone. In other words, a second reference position of a base bone and a second reference position of a neighbor bone of the base bone are concatenated to obtain concatenating position information of the base bone.

The processing device may invoke the skinning network to perform feature embedding processing on concatenating position information (which may be placed in the same feature matrix) of the M base bones to generate the transition bone features of the M base bones. That is, features obtained after the feature embedding processing is performed on the concatenating position information of the M base bones are referred to as transition bone features. A dimension of the transition bone feature may be (M, C1), and C1 is a positive integer. That is, one base bone may correspond to one C1-dimensional feature in the transition bone feature.

The processing device may obtain the basic features of the N motion points, and the basic features may be obtained after combination processing is performed on the first reference positions of the N motion points and the normal information of the N motion points.

The processing device may perform feature interaction processing on the basic features of the N motion points and the transition bone features, to generate the motion point interaction features of the N motion points and the bone interaction features of the M base bones. The bone interaction features are features generated after features of the basic features of the N motion points are further exchanged based on the transition bone features. The motion point interaction features may be features generated after features of the transition bone features are further exchanged based on the basic features of the N motion points.

In some aspects, described herein, feature interaction processing may be performed on the basic features of the N motion points and the transition bone features by using a cross attention mechanism of a sequence model based on an attention mechanism (Transformer). An operating principle of the cross attention mechanism may include: First, basic features of the N motion points may be decomposed to obtain queries, keys, and values of the N motion points, and transition bone features may be decomposed to obtain queries, keys, and values of the M base bones. The query represents a query vector of the key, the key represents a key value, and the value represents an eigenvalue corresponding to the key. Therefore, in the cross attention mechanism, corresponding keys may be found by using the queries of the N motion points and the M base bones (a query result is a result of self-learning by the cross attention mechanism), and then attention mechanism processing (that is, feature interaction) is performed on the value of the motion point and the value of the bone based on the found keys, to finally generate the motion point interaction feature and the bone interaction feature.

The bone interaction features are the foregoing generated bone position features of the M base bones.

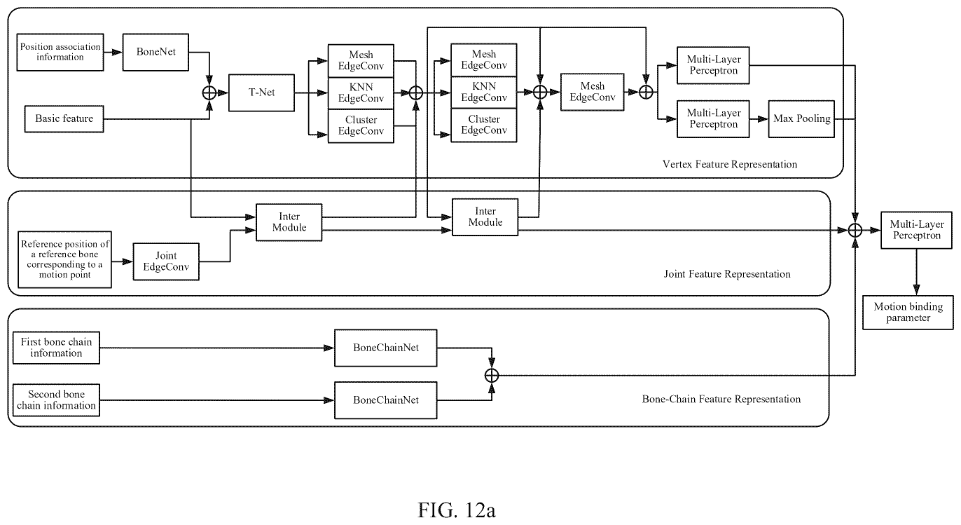

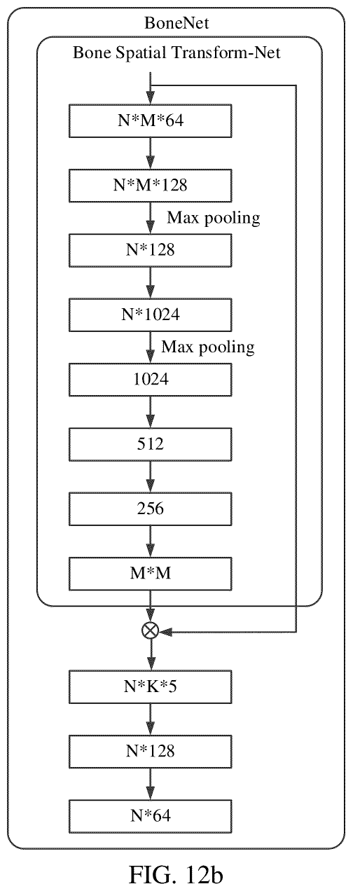

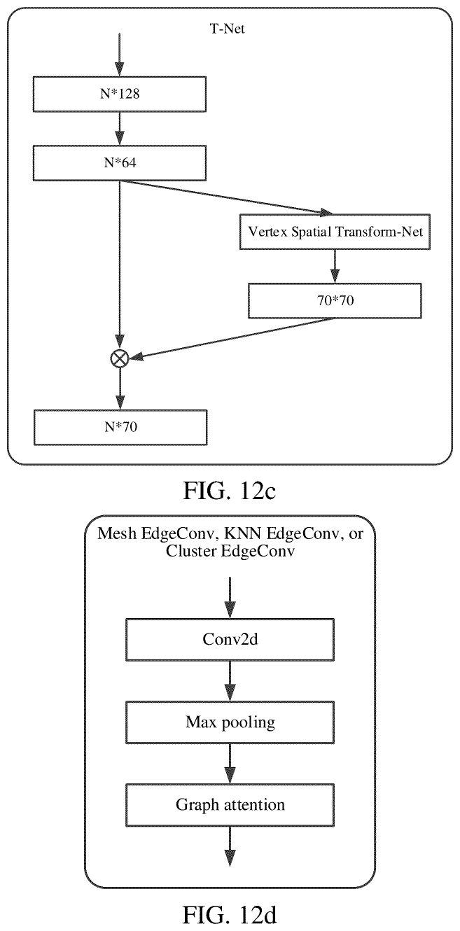

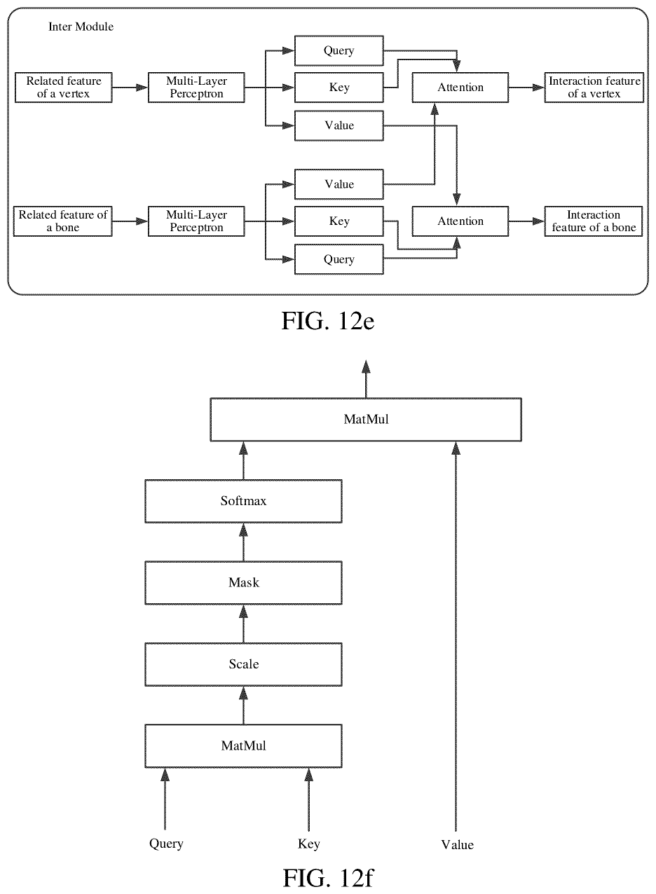

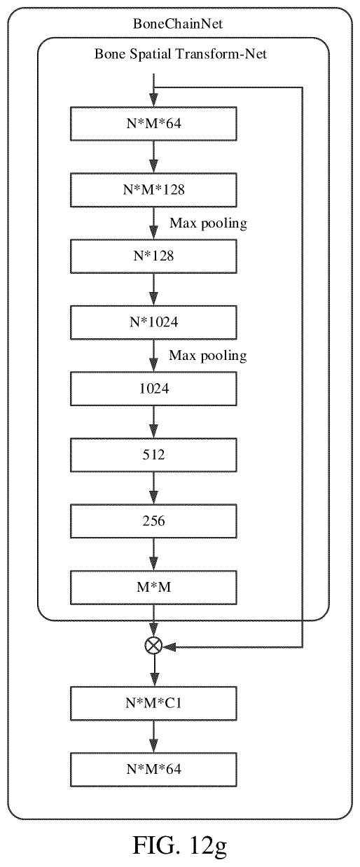

Referring to FIG. 12a to FIG. 12g, FIG. 12a is a schematic structural diagram 1 of a skinning network according to an aspect described herein; FIG. 12b is a schematic structural diagram 2 of a skinning network according to an aspect described herein; FIG. 12c is a schematic structural diagram 3 of a skinning network according to an aspect described herein; FIG. 12d is a schematic structural diagram 4 of a skinning network according to an aspect described herein; FIG. 12e is a schematic structural diagram 5 of a skinning network according to an aspect described herein; FIG. 12f is a schematic structural diagram 6 of a skinning network according to an aspect described herein; and FIG. 12g is a schematic structural diagram 7 of a skinning network according to an aspect described herein. As shown in FIG. 12a, the skinning network may include a vertex feature representation, a join feature representation, and a bone-chain feature representation.

A symbol with a plus sign inside a circle in the figure indicates concatenating. First, the vertex feature representation is described: The vertex feature representation is configured for generating the motion point global feature. An input to BoneNet in the vertex feature representation may be position association information between the N motion points and the corresponding base bones. An output of BoneNet (a neural network configured to encode position information of a base bone into position information of a vertex) may be the bone association feature. An input to T-Net (a neural network configured to perform feature transform) in the vertex feature representation may be the initial representation features of the N motion points obtained by concatenating the bone association features and the basic features of the N motion points. An output of T-Net may be the motion point transform feature.

Next, the vertex feature representation may include two EdgeConv modules (a neural network configured to extract a field feature). The first EdgeConv module may include Mesh EdgeConv (a neural network configured to embed a transform feature of a motion point and a transform feature of a neighboring motion point of the motion point that is obtained based on the first manner), KNN EdgeConv (a neural network configured to embed a transform feature of a motion point and a transform feature of a neighboring motion point of the motion point that is obtained based on the second manner), and Cluster EdgeConv (a neural network configured to embed a transform feature of a motion point and a transform feature of a neighboring motion point of the motion point that is obtained based on the third manner). The Mesh EdgeConv, the KNN EdgeConv, and the Cluster EdgeConv are each configured for generating the initial neighbor association features respectively corresponding to the N motion points.

Further, the second EdgeConv module may also include Mesh EdgeConv (a neural network configured to embed an initial neighbor association feature of a motion point and an initial neighbor association feature of a neighboring motion point of the motion point that is obtained based on the first manner), KNN EdgeConv (a neural network configured to embed an initial neighbor association feature of a motion point and an initial neighbor association feature of a neighboring motion point of the motion point that is obtained based on the second manner), and Cluster EdgeConv (a neural network configured to embed an initial neighbor association feature of a motion point and an initial neighbor association feature of a neighboring motion point of the motion point that is obtained based on the third manner). The Mesh EdgeConv, the KNN EdgeConv, and the Cluster EdgeConv are each configured for finally generating the neighbor association features respectively corresponding to N motion points. By using the foregoing method, a motion point may have three neighbor association features. Herein, an initial neighbor association feature of a motion point outputted by the first EdgeConv module and a neighbor association feature of a motion point outputted by the second EdgeConv module may be concatenated, to obtain the target neighboring feature. An input to the second EdgeConv module may be a feature obtained by concatenating an input to the first EdgeConv module and an initial interaction feature that is of a motion point and that is outputted by a first InterModule module in the following joint feature representation module.

According to the foregoing process, most position features of the vertex and the base bone have been learned, and attention may be focused on a structural feature between motion points (for example, a feature between a motion point and an adjacent motion point of the motion point). Therefore, the Mesh EdgeConv may be further connected behind the second EdgeConv module, and a feature between a motion point and an adjacent motion point of the motion point may be extracted more deeply by using the Mesh EdgeConv. An input to the Mesh EdgeConv may be a target motion point feature obtained by concatenating the target neighboring feature and the motion point interaction feature outputted by the second InterModule module in the joint feature representation module.

Data processing performed on the target motion point feature by starting from the Mesh EdgeConv after the second EdgeConv module in the vertex feature representation, to two MLP network layers connected above and below subsequently (Max Pooling is further connected behind the MLP network layer below) may be understood as feature reforming processing on the target motion point feature. Herein, the MLP connected above is configured for performing feature space (because the concatenation feature space may be understood as a space including a plurality of neighboring features) uniformization on features outputted by the EdgeConv. The MLP and Max Pooling connected below are configured for performing transform and reforming processing on the features outputted by the EdgeConv. Finally, an output of the LMP connected above and an output of the Max Pooling connected below are concatenated, to obtain the foregoing motion point global feature.

Next, the joint feature representation module is described: The joint feature representation module may be configured to generate the bone interaction feature. An input to the joint feature representation module may be the second reference position of the base bone corresponding to the motion point. The joint feature representation module may include Joint EdgeConv. Feature embedding processing may be performed on concatenating position information of each base bone by using the Joint EdgeConv (a neural network configured for performing feature association embedding on a base bone and a neighbor bone of the base bone), to generate the transition bone features of the M base bones.

Next, two InterModule modules (neural networks configured to perform feature interaction processing) are connected after the Joint EdgeConv. Operating principles of the two InterModule modules may be the same, and the two InterModule modules both use the operating principle of the foregoing cross attribution mechanism. An input to the first InterModule module may be the basic features of the N motion points and the transition bone feature outputted by the Joint EdgeConv. An output of the first InterModule module may include an initial interaction feature of a motion point and an initial interaction feature of a base bone. An input to the second InterModule module may be an output of the first InterModule module, so that the motion point interaction feature and the bone interaction feature may be outputted by using the second InterModule module. The motion point interaction feature may flow into the vertex feature representation, and the bone interaction feature is retained in the vertex feature representation module. The bone interaction feature is the generated bone position feature.

Herein, for ease of description, a process of generating the following bone chain structural feature is described. The foregoing bone-chain feature representation is configured for generating the bone chain structural feature. The bone-chain feature representation may include two BoneChainNet (neural networks configured to extract bone-chain features). An input to the BoneChainNet connected above is the following first bone chain information, and an output of the BoneChainNet may be the following first bone chain embedding feature. An input to the BoneChainNet connected below is the following second bone chain information. An output of the BoneChainNet may be the following second bone chain embedding feature. A bone chain structural feature may be generated by performing fusion processing on the first bone chain embedding feature and the second bone chain embedding feature. The fusion processing may be concatenating processing, or may be other processing, and may be specifically determined according to an actual application scenario.

Further, the global prediction feature may be generated by concatenating the motion point global feature generated by the vertex feature representation, the bone position feature generated by the joint feature representation, and the bone chain structural feature generated by the bone-chain feature representation. Further, the global prediction feature is inputted into the last connected MLP network layer in the skinning network, so that the motion binding parameter between each motion point and the corresponding base bone can be obtained through prediction.

A network structure of the BoneNet network in the skinning network in FIG. 12a may be shown in FIG. 12b. Multidimensional transform (which belongs to a feature learning process) may be performed on the inputted feature by using the BoneNet network, and finally, a feature whose dimension is N*64 (or may be another dimension) may be outputted. Transform between feature dimensions in the BoneNet may be implemented by using a linear network layer.

A network structure of the T-Net network in the foregoing skinning network may be shown in FIG. 12c. The vertex spatial Transform-Net belongs to a feature space transform neural network. Feature dimension transform may also be performed on an inputted feature by using the T-Net network, and a feature whose dimension is N*70 (or may be another dimension) is finally outputted. Transform between feature dimensions in the T-Net network may also be implemented by using a linear network layer.

Structures of the Mesh EdgeConv, the KNN EdgeConv, and the Cluster EdgeConv are the same. A data processing principle is the same, but different types of neighboring motion points are used. In some aspects, the structure may be a structure shown in FIG. 12d. The structure shown in FIG. 12d may include a Conv2d (convolution layer), a Max Pooling (maximum pooling layer), and a Graph attention (attention mechanism layer).

Network structures of the two Inter Module networks in the foregoing skinning network may both be shown in FIG. 12e. The Inter Module network may include two MLP network layers and two attention network layers. An input to the upper MLP network layer is a related feature of a vertex. For example, an input to the upper MLP in the first Inter Module network is basic features of N vertexes, and an input to the lower MLP in the first Inter Module network is a bone transition feature. An input to the lower MLP network layer is a related feature of a base bone. For example, an input to the upper MLP in the second Inter Module network is initial interaction features of the N vertexes, and an input to the lower MLP in the second Inter Module network is an initial interaction feature of the base bone.

In some aspects, a structure of the attention network layer in the Inter Module network may be shown in FIG. 12f. The attention network layer may include MatMul (a matrix multiplication function layer), Scale (a scale conversion layer), Mask (a mask layer), and softmax (a normalization layer).

A network structure of the BoneChainNet network in the skinning network may be shown in FIG. 12g. Multidimensional transform (which belongs to a feature learning process) may be performed on an inputted feature by using the BoneChainNet network, and finally, a feature whose dimension is N*M*64 (or may be another dimension) may be outputted. Transform between feature dimensions in the BoneChainNet may be implemented by using a linear network layer.

By using the foregoing method described herein, feature interaction learning can be performed on the position features of the N motion points and the position features of the M base bones, and finally, accurate motion point global features configured for representing global position features between the N motion points and the corresponding base bones and bone position features configured for representing the global position features of the M base bones can be generated.

Referring to FIG. 13, FIG. 13 is a schematic flowchart of another feature generation method according to an aspect described herein. This aspect described herein describes a process of generating the bone chain structural features associated with the foregoing M base bones. As shown in FIG. 13, the method may include:

Operation S401: Obtain an associated joint of each base bone on a bone chain on which the base bone is located. Any bone chain includes a plurality of base bones connected to each other, a joint of any bone chain refers to a bone connection between base bones included in the bone chain, and an associated joint of any base bone includes one or more adjacent joints of the base bone on the bone chain on which the base bone is located.

In some aspects, one bone chain may include a plurality of base bones connected to each other, one bone chain may include one or more joints, and one joint of the bone chain may refer to a bone connection between base bones included in the bone chain (for example, a connection at a vertex of the base bone).

The processing device may obtain an associated joint (which may be referred to as a superior joint) of each of the M base bones on a bone chain on which the base bone is located. An associated joint of any base bone may include one or more joints adjacent to the base bone on the bone chain on which the any base bone is located. A quantity of associated joints of a base bone may be determined based on an actual application scenario.

For example, if there are two associated joints of one base bone, the two associated joints of the base bone may include a parent joint (which may also be referred to as a parent node) and a grandfather joint (which may also be referred to as a grandfather node, that is, the parent joint of the parent joint of the base bone) of the base bone on a bone chain on which the base bone is located. If a quantity of associated nodes of a base bone is another quantity, this principle may also be configured for analogy to obtain each associated node of each base bone.

Operation S402: Separately perform combination processing on the second reference position of the base bone corresponding to each motion point and a third reference position of the associated joint of the base bone corresponding to the motion point, to obtain first bone chain information associated with the motion point.

In some aspects, each joint in the bone chain formed by the foregoing M base bones may also have a respective reference position (which may also be three-dimensional, and the reference position of the joint may be referred to as a third reference position), and the third reference position may also be a start position of the joint when the first object model carries the second object model in a standard object posture (a static posture). Therefore, the processing device may obtain the third reference position of the joint on the bone chain formed by the M reference bones.

The processing device may separately perform combination processing (for example, concatenating) on the second reference position of the base bone corresponding to each motion point and a third reference position of the associated joint of the base bone corresponding to the motion point, to obtain first bone chain information associated with the motion point. In other words, the second reference position of the base bone corresponding to any motion point and the third reference position of the associated joint of the base bone are combined to obtain the first bone chain information associated with the motion point. If there are two associated nodes of a base bone, and a quantity of base bones corresponding to one motion point is R, a dimension of first bone chain information associated with one motion point may be (R, 9), that is, a second reference position of one base bone corresponding to one motion point and third reference positions of two associated joints of the base bone may form one piece of 9-dimensional information in the first bone chain information.

Therefore, a total dimension of the first bone chain information associated with the N motion points may be represented as (N, R, 9).

Operation S403: Perform combination processing on position distance information between each motion point and the corresponding base bone and position distance information between the motion point and the associated joint of the corresponding base bone, to obtain second bone chain information associated with the motion point.

In some aspects, the processing device may obtain and calculate position distance information between each motion point and a corresponding base bone. There may be one piece of position distance information between one motion point and one corresponding base bone of the motion point. In some aspects, the position distance information may include a Euclidean distance (one dimension) and a geodesic distance (one dimension) between a first reference position of the motion point and a corresponding second reference position of the base bone.

The processing device may further calculate position distance information between each motion point and an associated joint of a corresponding base bone. There may be one piece of position distance information between one motion point and one associated joint of one base bone corresponding to the motion point. In some aspects, the position distance information may also include a Euclidean distance (one dimension) and a geodesic distance (one dimension) between a reference position of the motion point and a corresponding third reference position of the associated joint of the base bone.

The processing device may perform combination processing (for example, concatenating) on position distance information between each motion point and the corresponding base bone and position distance information between the motion point and the associated joint of the corresponding base bone, to obtain second bone chain information associated with the motion point. One motion point may have one piece of second bone chain information, and the second bone chain information may include position distance information between the motion point and a corresponding base bone and position distance information between the motion point and an associated joint of the corresponding base bone.

Therefore, if there are two associated joints of a base bone, position distance information between one motion point and one corresponding base bone and position distance information between the motion point and an associated joint of the base bone form one piece of 6 (3*2)-dimensional information. If a quantity of base bones corresponding to each motion point is R, a dimension of second bone chain information associated with any motion point may be (R, 6), and a total dimension of second bone chain information associated with N motion points is (N, R, 6).

Operation S404: Generate the bone chain structural feature based on the first bone chain information and the second bone chain information associated with each motion point.

In some aspects, the processing device may perform feature embedding processing on the first bone chain information associated with the N motion points (where a dimension may be (N, R, 9) in total, and the first bone chain information associated with the N motion points may be placed in the same feature matrix) together, to obtain the first bone chain embedding features associated with the N motion points.

Similarly, the processing device may perform feature embedding processing on the second bone chain information associated with the N motion points (where a dimension may be (N, R, 6) in total, and the second bone chain information associated with the N motion points may also be placed in the same feature matrix) together, to obtain the second bone chain embedding features associated with the N motion points.

Further, the processing device may concatenate the first bone chain embedding feature and the second bone chain embedding feature obtained above, to generate the foregoing bone chain structural feature. Because the bone chain structural feature is obtained based on the second reference positions of the base bones corresponding to the N motion points, the third reference positions of the associated joints of the base bones corresponding to the N motion points, and the position distances between the N motion points and the associated joints of the corresponding base bones (which may be embodied by using the foregoing position distance information), the bone chain structural feature includes joint information of a bone chain on which the base bones corresponding to the N motion points are located, and a position of the base bone included in the bone chain and a position of a joint included in the bone chain may be configured for representing a structure of the bone chain. Therefore, the bone chain structural feature may be configured for reflecting a structural feature of a bone chain on which the base bones corresponding to the N motion points are located.

By using the foregoing process, feature embedding processing is performed by associating the first reference positions of the N motion points, the second reference positions of the base bones corresponding to the N motion points, and the third reference positions of the associated joints of the base bones corresponding to the N motion points, to accurately generate the bone chain structural features associated with the N motion points.

Referring to FIG. 14, FIG. 14 is a schematic flowchart of a network training method according to an aspect described herein. This aspect described herein describes a specific process of obtaining the skinning network through training. As shown in FIG. 14, the method may include:

Operation S501: Obtain a first sample object model, the first sample object model including G sample base bones or some of the G sample base bones, and G being a natural number.

In some aspects, the processing device may obtain the first sample object model. A concept of the first sample object model is the same as the concept of the foregoing first object model. The first sample object model may include G sample base bones or some base bones of the G sample base bones. A concept of the G sample base bones is the same as that of the M base bones, and G is a natural number.

Operation S502: Obtain a second sample object model, the second sample object model including K sample motion points, each sample motion point corresponding to one or more sample base bones of the G sample base bones, the K sample motion points being configured for defining motion of the second sample object model, K being a natural number, the K sample motion points each having a sample label, and a sample label of any sample motion point being configured for indicating a real motion binding parameter between the any sample motion point and a corresponding sample base bone.

In some aspects, the processing device may further obtain the second sample object model. A concept of the second sample object model is the same as the concept of the foregoing second object model. The second sample object model may move with the first sample object model. The second sample object model may have K sample motion points, where K is a natural number. A concept of the K sample motion points is the same as the concept of the foregoing N sample motion points. The K sample motion points are configured for defining (or representing) motion of the second sample object model, and details are not described herein again.

Therefore, the G sample base bones may include all bones affecting motion of the K sample motion points in the first object model, and according to a requirement in an actual application scenario, the G sample base bones may further include or might not include an auxiliary bone configured to assist the second sample object model in moving.

Similarly, each sample motion point may correspond to one or more sample base bones of the G sample base bones, and one sample motion point may move with a corresponding sample base bone. Therefore, the processing device can obtain a sample base bone corresponding to each sample motion point in the G sample base bones.

More, each sample motion point may have a sample label. A sample label of any sample motion point is configured for indicating a real motion binding parameter between the sample motion point and a corresponding sample base bone. A sample motion point may have a real motion binding parameter between the sample motion point and a corresponding sample base bone. The real motion binding parameter is a correct target that a finally predicted motion binding parameter needs to reach.

A real motion binding parameter between a sample motion point and a corresponding sample base bone may be manually marked by a professional artist based on a motion effect that actually needs to be achieved when each sample motion point in the second sample object model moves with a corresponding sample base bone.

Operation S503: Determine a fourth reference position of each sample motion point and a fifth reference position of each sample base bone of the G sample base bones.

In some aspects, each sample motion point and each sample base bone may have respective reference positions. A reference position of a sample motion point may be referred to as a fourth reference position, and a reference position of a sample base bone may be referred to as a fifth reference position. A manner of determining the fourth reference position of each sample motion point and the fifth reference position of each sample base bone is the same as the manner of determining the reference positions of the N motion points and the M base bones, and details are not described herein again.

Therefore, the processing device can determine the fourth reference position of each sample motion point and the fifth reference position of each sample base bone. The fourth reference position and the fifth reference position may be obtained when the first sample object model and the second sample object model are obtained.

Operation S504: Invoke a skinning network to be trained, and perform conversion processing on the fourth reference position and the fifth reference position, to generate a sample global prediction feature corresponding to the K sample motion points, the sample global prediction feature being configured for reflecting global position features between the K sample motion points and corresponding sample base bones, position features of the G sample base bones, and structural features of bone chains on which the sample base bones corresponding to the K sample motion points are located.

In some aspects, the processing device may obtain the skinning network to be trained. The skinning network to be trained is a network configured for performing overall skinning. The processing device may invoke the skinning network to be trained to perform feature embedding processing on the fourth reference positions of the K sample motion points and the fifth reference positions of the G sample base bones, to generate a sample global prediction feature for the K sample motion points. The sample global prediction feature may be configured for reflecting a global position feature between the K sample motion points and corresponding sample base bones, position features of the G sample base bones, and structural features of bone chains in which the base bones corresponding to the K sample motion points are located.

A process of invoking the skinning network to be trained to perform conversion processing (which may be feature embedding processing) on the fourth reference positions of the K sample motion points and the fifth reference positions of the G sample base bones, to generate the sample global prediction feature is the same as the foregoing process of invoking the skinning network to perform conversion processing on the first reference positions of the N motion points and the second reference positions of the M base bones, to generate the global prediction feature. Details are not described herein again.

A concept of the sample global prediction feature herein is also the same as the concept of the foregoing global prediction feature.

Operation S505: Invoke the skinning network to be trained to predict a sample motion binding parameter between each sample motion point and the corresponding sample base bone based on the sample global prediction feature.

In some aspects, the processing device may invoke the skinning network to be trained to predict a sample motion binding parameter between each sample motion point and a corresponding sample base bone based on the sample global prediction feature. A process of invoking the skinning network to be trained to predict the sample motion binding parameter between each sample motion point and the corresponding sample base bone is the same as the foregoing process of invoking the skinning network to predict the motion binding parameter between each motion point and the corresponding base bone, and details are not described herein again.

Operation S506: Correct, based on a difference between the sample motion binding parameter predicted for each sample motion point and a real motion binding parameter indicated by a sample label of each sample motion point, a network parameter of the skinning network to be trained, to obtain the skinning network.

In some aspects, a predicted sample motion binding parameter between a sample motion point and a corresponding sample base bone may be referred to as a sample motion binding parameter corresponding to the sample motion point (sample motion binding parameters between the sample motion point and all corresponding sample base bones may be represented by using a sequence or a vector), and a real motion binding parameter indicated by a sample label of the sample motion point may be referred to as a real motion binding parameter corresponding to the sample motion point (real motion binding parameters between the sample motion point and all corresponding sample base bones may also be represented by using a sequence or a vector).

The processing device may generate, based on the sample motion binding parameter and the real motion binding parameter corresponding to each sample motion point, the global parameter prediction deviation of the skinning network to be trained for the sample motion binding parameter and the motion position prediction deviation of the second sample object model.

The global parameter prediction deviation directly reflects the difference between the sample motion binding parameter corresponding to each sample motion point and the real motion binding parameter. A larger global parameter prediction deviation indicates a larger difference between the sample motion binding parameter corresponding to each sample motion point and the real motion binding parameter. Otherwise, a smaller global parameter prediction deviation indicates a smaller difference between the sample motion binding parameter corresponding to each sample motion point and the real motion binding parameter. The global parameter prediction deviation may be KL-Loss (a divergence loss, configured for measuring a similarity between two distributions), and is shown in the following formula:

$${Loss}_{KL} = \frac{1}{K} ( {\sum }_{k = 1}^{K} {\sum }_{g = 1}^{G} log \frac{{p}_{kg}}{} ) \qquad ( 4 )$$

where LOSS_{KL} is the global parameter prediction deviation, G is a quantity of sample base bones, K is a quantity of sample motion points, k is a positive integer less than or equal to K, k is configured for representing any one of the K sample motion points, g is a positive integer less than or equal to G, and g is configured for representing any one of the G sample base bones. [symbol] represents a predicted sample motion binding parameter between a sample motion point k and a sample base bone g,p_{kg} represents a real motion binding parameter (a real motion binding parameter indicated by a sample label of the sample motion point k) between the sample motion point k and the sample base bone g, and log represents taking a logarithm.

The motion position prediction deviation is configured for reflecting differences between positions of the K sample motion points after the K sample motion points move based on the predicted sample motion binding parameter and positions of the K sample motion points after the K sample motion points move based on the real motion binding parameter. The motion position prediction deviation may also be referred to as a deformation loss of the second sample object model. The following content describes that a process of generating the motion position prediction deviation may include the following:

The processing device may preset several sample object postures for the first sample object model. The several sample object postures may be several object postures to which the first sample object model needs to move. A quantity of sample object postures may be determined according to an actual application scenario. This is not limited.

Further, the processing device may calculate, by using the LBS algorithm in the foregoing formula (1), a predicted motion position of each sample motion point by using a sample motion binding parameter predicted for the sample motion point, a start position of the sample motion point, and a motion parameter of a sample base bone corresponding to the sample motion point (the motion parameter may be determined based on the foregoing set sample object posture, the motion parameter may be a translation matrix and a transfer matrix of the sample base bone when the first sample object model moves to the sample object posture, and the motion parameter may be configured for determining a distance by which the sample base bone needs to be translated, an angle by which the sample base bone rotates, and the like). The predicted motion position is a position of each sample motion point obtained through calculation by using a sample motion binding parameter predicted for the sample motion point, a start position of the sample motion point, and a motion parameter of a sample base bone corresponding to the sample motion point after the first sample object model moves to the sample object posture. A concept of the start position of the sample motion point is the same as the concept of the start position of the foregoing motion point.

Similarly, the processing device may further calculate a real motion position of each sample motion point by using a real motion binding parameter indicated by a sample label of the sample motion point, a start position of the sample motion point, and a motion parameter (determined based on the specified sample object posture) of a sample base bone corresponding to the sample motion point, and also by using the LBS algorithm in the foregoing formula (1).

Further, the processing device may generate the motion position prediction deviation according to the predicted motion position and the real motion position of each sample motion point. The motion position prediction deviation may be a mean square error (MSE) between the predicted motion position and the real motion position of each sample motion point. The mean square error is configured for reflecting a difference between the predicted motion position and the real motion position of each sample motion point. A larger mean square error indicates a larger difference, as shown in the following formula:

$${Loss}_{deformation} = MSE ( pos , ) \qquad ( 5 )$$

where LOSS deformation is the motion position prediction deviation, pos may represent real motion positions of the K sample motion points, and [symbol] may represent predicted motion positions of the K sample motion points.

Further, the processing device may further generate neighborhood parameter prediction deviations for the K sample motion points according to a difference between sample motion binding parameters corresponding to adjacent sample motion points in the K sample motion points and a difference between real motion binding parameters corresponding to adjacent sample motion points in the K sample motion points. The neighborhood parameter prediction deviation may be configured for reflecting a deviation between the two differences: the difference between sample motion binding parameters predicted for adjacent sample motion points in the K sample motion points and the difference between real motion binding parameters corresponding to adjacent sample motion points in the K sample motion points.

In some aspects, a process of generating the neighborhood parameter prediction deviation may include the following:

First, the processing device may calculate a parameter distance between a sample motion binding parameter corresponding to each sample motion point (sample motion binding parameters between a sample motion point and all corresponding sample base bones may be represented by using a sequence or a vector) and a sample motion binding parameter corresponding to an adjacent sample motion point of the sample motion point. For example, the parameter distance may be an L1 distance (a Manhattan distance) or a vector distance. There may be one parameter distance between a sample motion binding parameter corresponding to one sample motion point and a sample motion binding parameter corresponding to one adjacent sample motion point of the sample motion point. An adjacent sample motion point of a sample motion point may include other sample motion points that are in a mesh of the second sample object model and that have a connection relationship with the sample motion point, and an adjacent sample motion point of a sample motion point may be a neighboring sample motion point of the sample motion point.

Further, the processing device may obtain, by using the parameter distance between the sample motion binding parameter corresponding to each sample motion point and a sample motion binding parameter corresponding to an adjacent sample motion point of the sample motion point, predicted parameter distances corresponding to the K sample motion points. The predicted parameter distances include parameter distances between the sample motion binding parameters corresponding to the K sample motion points and the sample motion binding parameters corresponding to adjacent sample motion points of the K sample motion points. The predicted parameter distances may be understood as a set including parameter distances between the sample motion binding parameters corresponding to the K sample motion points and the sample motion binding parameters corresponding to the adjacent sample motion points of the K sample motion points.

Similarly, the processing device may further calculate a parameter distance between a real motion binding parameter corresponding to each sample motion point and a real motion binding parameter corresponding to an adjacent sample motion point of the sample motion point. The parameter distance may alternatively be an L1 distance (a Manhattan distance), a vector distance, or the like. There may alternatively be one parameter distance between a real motion binding parameter corresponding to one sample motion point and a real motion binding parameter corresponding to one adjacent sample motion point of the sample motion point.

Further, the processing device can obtain, according to the parameter distance between the real motion binding parameter corresponding to each sample motion point and the real motion binding parameter corresponding to the adjacent sample motion point of the sample motion point, real parameter distances corresponding to the K sample motion points. The real parameter distances includes parameter distances between the real motion binding parameters corresponding to the K sample motion points and the real motion binding parameters corresponding to the adjacent sample motion points of the K sample motion points. The real parameter distances may be understood as a set including parameter distances between the real motion binding parameters corresponding to the K sample motion points and the real motion binding parameters corresponding to the adjacent sample motion points of the K sample motion points.

The foregoing neighborhood parameter prediction deviation may be a mean square error (MSE) between the foregoing predicted parameter distance and real parameter distance. The mean square error may be configured for reflecting a difference between the predicted parameter distance and the real parameter distance. A larger mean square error indicates a larger difference between the predicted parameter distance and the real parameter distance. Therefore, the neighborhood parameter prediction deviation may be generated by using the difference between the predicted parameter distance and the real parameter distance. As shown in the following formula, the neighborhood parameter prediction deviation may be:

$${Loss}_{ngb} = MSE ( D , \hat{D} ) \qquad ( 6 )$$

where Loss_{ngb} is the neighborhood parameter prediction deviation, D represents the foregoing real parameter distance, and D represents the foregoing predicted parameter distance.

Further, the processing device may perform summation (which may be weighted and then added) on the global parameter prediction deviation, the motion position prediction deviation, and the neighborhood parameter prediction deviation, to obtain the target prediction deviations for the K sample motion points. The target prediction deviations are a final overall loss (which may be a loss function) of the sample motion binding parameters predicted by the skinning network to be trained for the K sample motion points. As shown in the following formula:

$${LOSS}_{mb} = {w}_{1} * {Loss}_{KL} + {w}_{2} * {Loss}_{deformation} + {w}_{3} * {Loss}_{ngb} \qquad ( 7 )$$

where LOSS_{mb} is a target prediction deviation, Loss_{KL} is a global parameter prediction deviation, Loss_{deformation} is a motion position prediction deviation, and Loss_{ngb} is a neighborhood parameter prediction deviation. w₁ is a weight coefficient of LOSS_{KL}, w₂ is a weight coefficient of Loss_{deformation}, and w₃ is a weight coefficient of Loss_{ngb}.

Specific values of w₁, w₂, and w₃ may be determined according to an actual application requirement, for example, according to relative importance among the global parameter prediction deviation, the motion position prediction deviation, and the neighborhood parameter prediction deviation. A higher weight coefficient may be set for a more important prediction deviation. Alternatively, weight coefficients of the global parameter prediction deviation, the motion position prediction deviation, and the neighborhood parameter prediction deviation each may be set to 1 or set to a particular value (for example, 0.3) less than 1. Specifically, the weight coefficients may be determined according to an actual application scenario. This is not limited.

The processing device may correct, by using the obtained target prediction deviation, the network parameter of the skinning network to be trained. A correction target is to make the target prediction deviation tend to be a minimum value (for example, tend to be 0). After the network parameter of the skinning network to be trained is corrected (for example, the network parameter of the skinning network to be trained is corrected to a convergent state, or a quantity of times of iterative training on the skinning network to be trained by using the foregoing principle reaches a specified times threshold), the trained skinning network (which may be briefly referred to as the skinning network) may be obtained.

By using the foregoing method described herein, a plurality of prediction deviations of a skinning network to be trained may be generated by using a difference between a sample motion binding parameter and a real motion binding parameter corresponding to a sample motion point, to evaluate and consider, from a plurality of dimensions, a sample motion binding parameter predicted by the skinning network to be trained. Finally, accurate correction of a network parameter of the skinning network to be trained may be implemented, to obtain an accurate skinning network through training. Accurate skinning between the first object model and the second object model may be implemented by using the skinning network obtained through training.

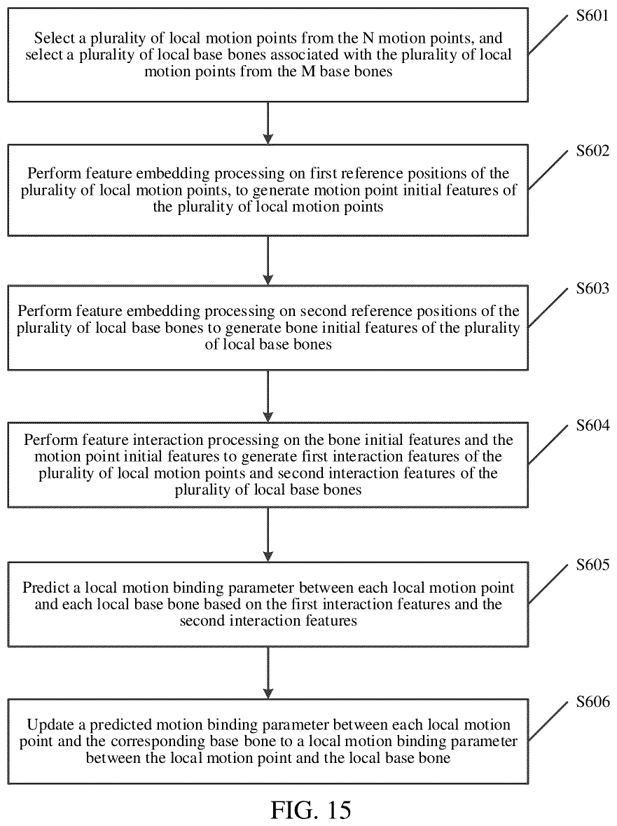

Referring to FIG. 15, FIG. 15 is a schematic flowchart of a local skinning method according to an aspect described herein. This aspect described herein describes a specific process of performing specific skinning on a local portion of the second object model. Because the second object model is entirely skinned by using the foregoing skinning network, in some specific scenarios, to satisfy skinning of a local motion point of the second object model with a specific effect, this application further provides the following local skinning manner. More specific requirements of an animator on skinning an object model may be satisfied by using this local skinning manner. As shown in FIG. 15, the method may include:

Operation S601: Select a plurality of local motion points from the N motion points, and select a plurality of local base bones associated with the plurality of local motion points from the M base bones.

In some aspects, the processing device may select a plurality of local motion points from the N motion points. The plurality of local motion points are motion points that are of the N motion points and on which local skinning needs to be performed. In some aspects, a picture that carries the second object model and that is of the first object model may be further visually displayed in a terminal device of an animator. The plurality of local motion points may be further selected by the animator from the visual picture that carries the second object model and that is of the first object model. Further, the plurality of local motion points selected by the animator may be transmitted by the terminal device to the processing device.

The processing device may further select a plurality of local base bones associated with the foregoing plurality of local motion points from the M base bones. The plurality of local base bones are base bones of the M base bones that affect motion of the plurality of local motion points. Similarly, the plurality of local base bones may also be selected by the animator from the visual picture of the first object model carrying the second object model, so that the plurality of local base bones selected by the animator can be transmitted by the terminal device to the processing device.

Subsequently, particular local skinning may be performed between the plurality of local motion points and the plurality of local base bones.

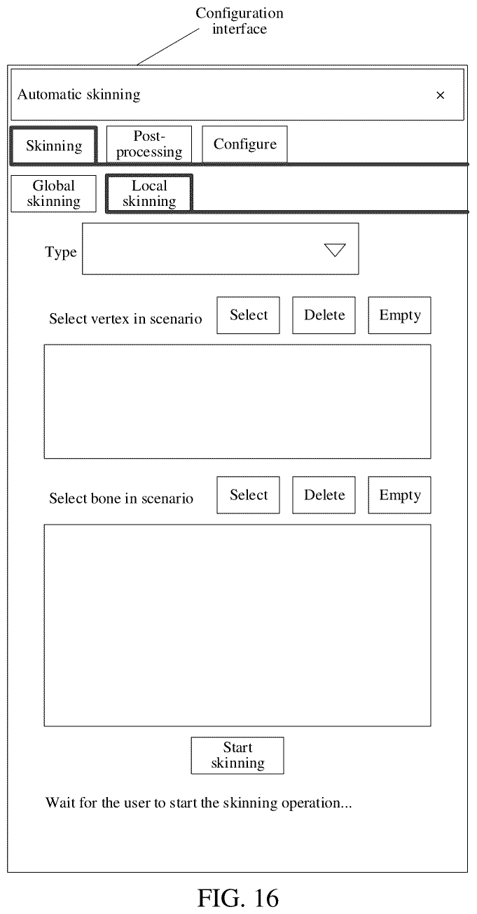

The user may also correspondingly configure local skinning in the foregoing skinning plug-in. Referring to FIG. 16, FIG. 16 is a schematic interface diagram of configuring local skinning according to an aspect described herein. The user may select, from the configuration interface shown in FIG. 16, vertexes (for example, the foregoing plurality of local motion points) on which local skinning needs to be performed and base bones (for example, the foregoing plurality of local base bones).

Operation S602: Perform feature embedding processing on first reference positions of the plurality of local motion points, to generate motion point initial features of the plurality of local motion points.

In some aspects, the processing device may perform feature embedding processing on first reference positions (which may be placed in the same feature matrix) of the plurality of local motion points, to generate motion point initial features of the plurality of local motion points, that is, features obtained by performing feature embedding processing on the first reference positions of the plurality of local motion points may be referred to as the motion point initial features.

Operation S603: Perform feature embedding processing on second reference positions of the plurality of local base bones to generate bone initial features of the plurality of local base bones.

In some aspects, the processing device may also perform feature embedding processing on second reference positions (which may be placed in the same feature matrix) of the plurality of local base bones to generate bone initial features of the plurality of local base bones. That is, features obtained after performing feature embedding processing on the second reference positions of the plurality of local base bones may be referred to as the bone initial features.

Operation S604: Perform feature interaction processing on the bone initial features and the motion point initial features to generate first interaction features of the plurality of local motion points and second interaction features of the plurality of local base bones.

In some aspects, the processing device may perform feature interaction processing on the bone initial features and the motion point initial features, to generate interaction features of the plurality of local motion points (which may be referred to as first interaction features) and interaction features of the plurality of local base bones (which may be referred to as second interaction features).

The principle of performing feature interaction processing on the initial representation features of the N motion points and the transition bone features of the M base bones is the same as that of the foregoing. Herein, feature interaction processing may be performed on the bone initial features and the motion point initial features by using the principle of cross attention of Transformer.

The first interaction feature is a feature obtained after a feature in the bone initial feature is exchanged based on the motion point initial feature, and the second interaction feature is a feature obtained after a feature in the motion point initial feature is exchanged based on the bone initial feature.

Operation S605: Predict a local motion binding parameter between each local motion point and each local base bone based on the first interaction features and the second interaction features.

In some aspects, the processing device may generate a global feature (which may be referred to as a first global feature, and the first global feature may be a feature vector) of the plurality of local motion points by using the first interaction features and the second interaction features. That is, the plurality of local motion points may share the first global feature.

The processing device may further generate a global feature (which may be referred to as a second global feature, and the second global feature may also be a feature vector) of the plurality of local base bones by using the first interaction features and the second interaction features. That is, the plurality of local base bones may share the second global feature.

In addition, the processing device generates first local features (the first local feature may be a feature matrix) of the plurality of local motion points by using the first interaction features and the second interaction features. The first local features may include a local feature of each local motion point. In other words, the local motion points may have respective local features in the first local features instead of sharing the same local feature.

Similarly, the processing device generates second local features (the second local feature may also be a feature matrix) of the plurality of local base bones by using the first interaction features and the second interaction features. The second local features may include a local feature of each local base bone. In other words, the local base bones may have respective local features in the second local features instead of sharing the same local feature.

The processing device may further calculate an interaction feature distance between the first interaction feature and the second interaction feature. In some aspects, the interaction feature distance may be a square distance between the first interaction feature and the second interaction feature.

Further, the processing device may predict a motion binding parameter (which may be referred to as a local motion binding parameter) between each local motion point and each local base bone by using the interaction feature distance, the first global feature, the first local feature, the second global feature, and the second local feature, as described in the following content.

A dimension of the first global feature may be (1, C2). If a quantity of the plurality of local motion points is Y1, a dimension of the first local feature may be (Y1, C2), and Y1 and C2 are both positive integers. Therefore, to keep the dimension of the first global feature consistent with the dimension of the first local feature, described herein, the first global feature may be further repeated for Y1 times, to obtain a global feature (which may be referred to as a repeated first global feature) whose dimension is (Y1, C2), and the repeated first global feature includes Y1 same first global features.

Further, the processing device may concatenate the repeated first global feature and the first local feature, to generate concatenation features of the plurality of local motion points. The concatenation features may be referred to as first concatenation features.

Similarly, a dimension of the second global feature may also be (1, C2). If a quantity of the plurality of local base bones is Y2, a dimension of the second local feature may be (Y2, C2). Therefore, to keep the dimension of the second global feature consistent with the dimension of the second local feature, described herein, the second global feature may be further repeated for Y2 times, to obtain a global feature (which may be referred to as a repeated second global feature) whose dimension is (Y2, C2), and the repeated second global feature includes Y2 same second global features.

Further, the processing device may perform concatenation processing on the repeated second global feature and the second local feature to generate concatenation features of the plurality of local base bones. The concatenation features may be referred to as second concatenation features.

The processing device may further obtain an adjacency matrix (which may be referred to as a first adjacency matrix) of the plurality of local motion points, and the first adjacency matrix may be configured for reflecting a connection relationship of the plurality of local motion points in a mesh of the second object model. If two local motion points are connected in the mesh of the second object model, a value at the same position corresponding to the two local motion points in the first adjacency matrix is 1; otherwise, if two local motion points are not connected in the mesh of the second object model, a value at the same position corresponding to the two local motion points in the first adjacency matrix is 0.

Similarly, the processing device may also obtain an adjacency matrix (which may be referred to as a second adjacency matrix) of the plurality of local base bones, and the second adjacency matrix may be configured for reflecting a connection relationship of the plurality of local base bones in the first object model. If two local base bones are connected in the first object model, a value at the same position corresponding to the two local base bones in the second adjacency matrix is 1; otherwise, if the two local base bones are not connected in the first object model, a value at the same position corresponding to the two local base bones in the second adjacency matrix is 0.

Further, the processing device may predict the local motion binding parameter between each local motion point and each local base bone by using the obtained first concatenation feature, second concatenation feature, first adjacency matrix, second adjacency matrix, and interaction feature distance, as described in the following content.

The processing device may perform a multiplication operation on the first concatenation feature and the first adjacency matrix, to generate adjacency features of the plurality of local motion points. The adjacency features may be referred to as first adjacency features. In some aspects, after a multiplication operation is performed on the first concatenation feature and the first adjacency matrix, an average pooling operation (Avg Pooling) may further be performed on a result of the multiplication operation, to generate the first adjacency feature.

The processing device may also perform a multiplication operation on the second concatenation feature and the second adjacency matrix to generate adjacency features of the plurality of local base bones. The adjacency features may be referred to as second adjacency features. In some aspects, after a multiplication operation is performed on the second concatenation feature and the second adjacency matrix, an average pooling operation (Avg Pooling) may further be performed on a result of the multiplication operation, to generate the second adjacency feature.

Next, the processing device may generate relative adjacency features between the plurality of local motion points and the plurality of local base bones based on differences between the first adjacency features and the second adjacency features. In some aspects, the relative adjacency feature may include a square distance between the first adjacency feature and the second adjacency feature and/or a difference between the first adjacency feature and the second adjacency feature (both the first adjacency feature and the second adjacency feature may be represented as a feature matrix, and the difference may be a feature matrix obtained by obtaining a difference between two feature matrices). The relative adjacency feature may be obtained by concatenating the square distance between the first adjacency feature and the second adjacency feature and the difference between the first adjacency feature and the second adjacency feature.

The processing device may concatenate the relative adjacency feature and the interaction feature distance, to generate a feature finally configured for predicting local motion binding parameters between the plurality of local motion points and the plurality of local base bones, and the feature may be referred to as a local prediction feature.

Finally, the processing device may perform prediction (that is, determining) to obtain a local motion binding parameter between each local motion point and each local base bone by using the foregoing local prediction feature, and a local motion binding parameter may be obtained through prediction between a local motion point and a local base bone.

The foregoing process of generating related features such as the motion point initial feature, the bone initial feature, the first interaction feature, the second interaction feature, the first local feature, the first global feature, the second local feature, the second global feature, the first concatenation feature, the second concatenation feature, the first adjacency feature, the second adjacency feature, the relative adjacency feature, and the local prediction feature and the process of predicting the local motion binding parameter between the local motion point and the local base bone based on the local prediction feature may all be obtained by invoking the trained local skinning network by the processing device. A principle of obtaining the local skinning network through training may be the same as the foregoing principle of obtaining the skinning network through training.

For example, a plurality of local sample motion points (the concept of the plurality of local motion points is the same as that of the plurality of local motion points, and may be some motion points selected from the K sample motion points of the second sample object model) and a plurality of local sample base bones (the concept of the plurality of local base bones is the same as that of the plurality of local base bones, and may be some sample base bones selected from the G sample base bones of the first sample object model) may be configured for training a local skinning network to be trained. The plurality of local sample motion points may have local sample labels. A local sample label of any local sample motion point may be configured for indicating a real local motion binding parameter between the local sample motion point and each local sample base bone, and a real local motion binding parameter indicated by a local sample label of the local sample motion point may be different from a real motion binding parameter indicated by a sample label of the local sample motion point.

Therefore, the processing device may invoke a local skinning network to be trained to predict the local motion binding parameter between each local sample motion point and each local sample base bone based on the same principle of predicting the local motion binding parameter between each local motion point and each local base bone.

Further, the processing device may generate the local prediction deviation of the local skinning network to be trained based on the difference between the local motion binding parameter predicted by the local skinning network to be trained and the real local motion binding parameter indicated by the local sample label of the local sample motion point according to the same principle of generating the target prediction deviation of the skinning network to be trained based on the difference between the sample motion binding parameter predicted by the skinning network to be trained and the real motion binding parameter indicated by the sample label of the sample motion point. That is, the principle of generating the local prediction deviation is the same as the principle of generating the target prediction deviation. Further, the processing device may correct, by using the local prediction deviation, a network parameter of the local skinning network to be trained, to obtain a trained local skinning network. The local motion binding parameters between the plurality of local motion points and the plurality of local base bones may be predicted by using the local skinning network.

Because the local skinning network obtained through training may achieve an objective that the animator wants the local motion point in the second object model to follow the local base bone to perform particular motion, the local skinning network to be trained may be trained based on an actual requirement of the animator (for example, a requirement that the local motion point in the second object model needs to follow the local base bone to perform particular motion to achieve a particular motion effect). For example, the local skinning network to be trained may be trained specifically by setting a particular local sample label for a local sample motion point.

For example, the animator may negotiate with an artist, so that the artist can set a corresponding local real motion binding parameter between a local sample motion point and a local sample base bone according to a particular effect that the animator wants the local motion point in the second object model to follow the local base bone to perform particular motion, that is, set a particular local sample label for the local sample motion point.

In the foregoing manner, by using the foregoing local skinning network obtained in a specific training manner, the local motion point in the second object model is made to follow the local base bone to perform specific move with a specific effect. Because the foregoing local skinning network is configured for performing local skinning between the first object model and the second object model, and the foregoing skinning network is configured for performing overall skinning (that is, global skinning) between the first object model and the second object model, a calculation amount of the local skinning network is less than a calculation amount of the skinning network. Therefore, a network parameter of the local skinning network may also be less than a network parameter of the skinning network.

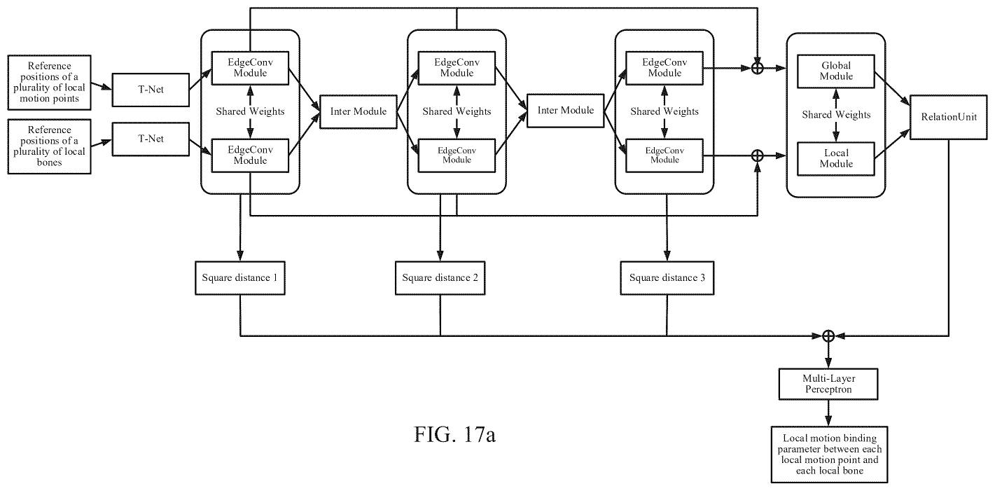

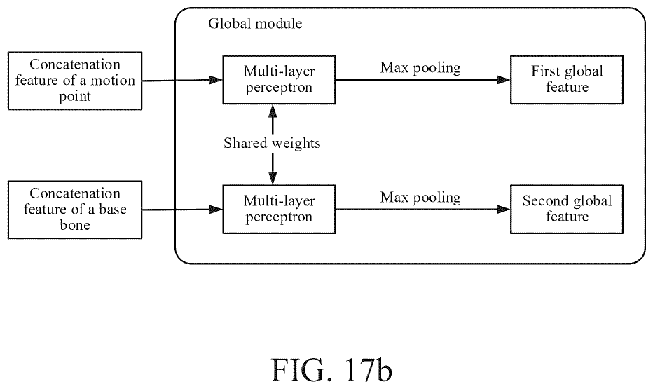

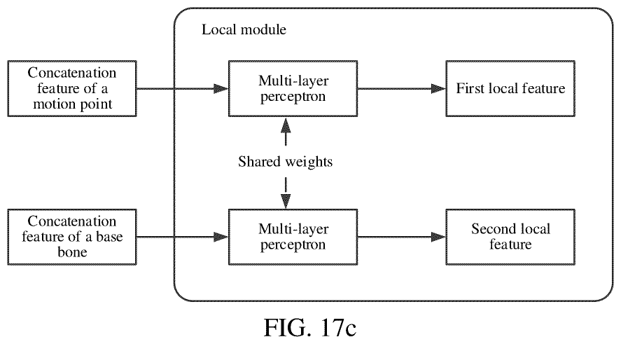

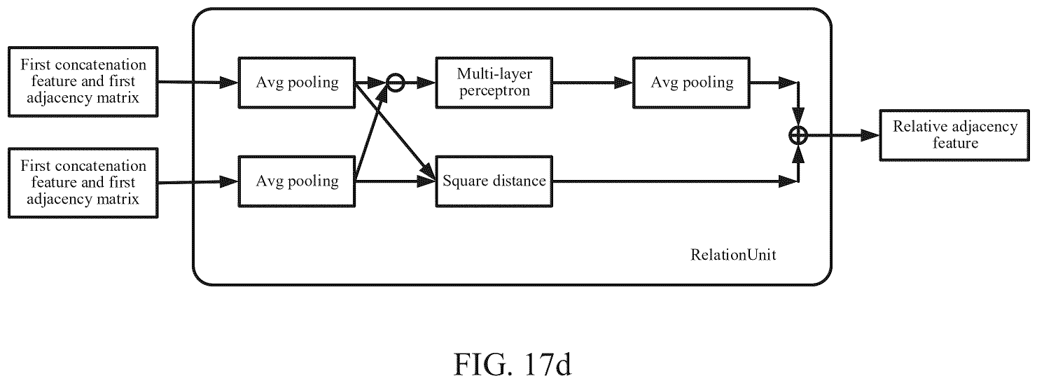

Referring to FIG. 17a to FIG. 17d, FIG. 17a is a schematic structural diagram 1 of a local skinning network according to an aspect described herein, FIG. 17b is a schematic structural diagram 2 of a local skinning network according to an aspect described herein, FIG. 17c is a schematic structural diagram 3 of a local skinning network according to an aspect described herein, and FIG. 17d is a schematic structural diagram 4 of a local skinning network according to an aspect described herein. As shown in FIG. 17a, the local skinning network may include six EdgeConvModule (that is, EdgeConv modules), two InterModule networks, and two T-Net networks. The EdgeConv modules, the InterModule networks, and the T-Net networks in the local skinning network may be the same (the structure may be the same) as the EdgeConv modules, the InterModule networks, and the T-Net networks in the foregoing skinning network, and data processing principles thereof are also the same. Details are not described herein again.

An output of the T-Net network connected above in the local skinning network may be the foregoing motion point initial feature, and an output of the T-Net network connected below in the local skinning network may be the foregoing bone initial features.

The six EdgeConvModule have three combined parts, the first combined part has two EdgeConvModule above and below, the second combined part also has two EdgeConvModule above and below, and the third combined part also has two EdgeConvModule above and below. The upper EdgeConvModule in each combined part is configured for extracting a neighboring feature related to a local motion point, and the lower EdgeConvModule in each combined part is configured for extracting a neighboring feature related to a local base bone.

The square distance 1 herein may be a square distance between the neighboring feature of the local motion point obtained by using the first combined part and the neighboring feature of the local base bone, the square distance 2 may be a square distance between the neighboring feature of the local motion point obtained by the second combined part and the neighboring feature of the local base bone, and the square distance 3 may be a square distance between the neighboring feature of the local motion point obtained by the third combined part and the neighboring feature of the local base bone.

The InterModule in the local skinning network may be configured for performing feature interaction between a neighboring feature of the local base bone and a neighboring feature of the local motion point. Herein, the feature related to the local motion point outputted by the third combined part may be referred to as a first interaction feature, and the feature related to the local base bone outputted by the third combined part may be referred to as a second interaction feature.

The local skinning network may further include GlobalModule (a neural network configured to extract a global feature), LocalModule (a neural network configured to extract a local feature), and RelationUnit (a neural network configured to perform feature mixing (fusion)).

The feature related to the local motion point obtained by the first combined part, the feature related to the local motion point obtained by the second combined part, and the feature related to the local motion point obtained by the third combined part (that is, the first interaction feature) may be concatenated, to obtain a concatenation feature of the local motion point. The concatenation feature may be inputted to the GlobalModule. The first global feature of the local motion point may be generated by using the GlobalModule.

Similarly, the feature related to the local base bone obtained by the first combined part, the feature related to the local base bone obtained by the second combined part, and the feature related to the local base bone obtained by the third combined part (that is, the second interaction feature) may be concatenated to obtain a concatenation feature of the local base bone. The concatenation feature may be inputted into the GlobalModule. The second global feature of the local base bone may be generated by using the GlobalModule.

Moreover, the feature related to the local motion point obtained by the first combined part, the feature related to the local motion point obtained by the second combined part, and the feature related to the local motion point obtained by the third combined part (that is, the first interaction feature) may be concatenated, to obtain a concatenation feature of the motion point. The concatenation feature may be inputted into the LocalModule. The first local feature of the local motion point may be generated by using the LocalModule.

Similarly, the feature related to the local base bone obtained by the first combined part, the feature related to the local base bone obtained by the second combined part, and the feature related to the local base bone obtained by the third combined part (that is, the second interaction feature) may be concatenated to obtain a concatenation feature of the local base bone. The concatenation feature may be inputted into the LocalModule. The second local feature of the local base bone may be generated by using the LocalModule.

Further, a process of generating the relative adjacency feature by using the first local feature, the second local feature, the first global feature, the second global feature, the first adjacency matrix, and the second adjacency matrix may be implemented by the RelationUnit network layer. That is, an input to the RelationUnit network layer may be the first local feature, the second local feature, the first global feature, the second global feature, the first adjacency matrix, and the second adjacency matrix, and an output of the RelationUnit network layer may be the relative adjacency feature.

Further, the relative adjacency feature, the square distance 1, the square distance 2, and the square distance 3 (the square distance 3 may be referred to as the interaction feature distance) may be concatenated, to generate a final local prediction feature. The local prediction feature is inputted into a finally connected MLP network layer in the local skinning network, to perform prediction to obtain the local motion binding parameter between each local motion point and each local base bone.

A network structure of the foregoing GlobalModule network layer may be shown in FIG. 17b. The GlobalModule network layer may include two MLP network layers (which may share a network parameter) and two max pooling network layers (maximum pooling layers).

A network structure of the foregoing LocalModule network layer may be shown in FIG. 17c. The LocalModule network layer may also include two MLP network layers (which may share a network parameter), but does not include a max pooling network layer.

A network structure of the RelationUnit network layer may be shown in FIG. 17d. The RelationUnit network layer may include three Avg pooling network layers (average pooling layers) and one MLP. An output of the first Avg pooling network layer above in the RelationUnit network layer may be referred to as the first adjacency feature, an output of the lower Avg pooling network layer in the RelationUnit network layer may be referred to as the second adjacency feature, and an output of the second Avg pooling network layer above in the RelationUnit network layer and a square distance in a lower branch of the RelationUnit network layer (which may be a square distance between the first adjacency feature and the second adjacency feature) may be referred to as the relative adjacency feature.

In some aspects, the skinning network and the local skinning network described herein may alternatively be networks based on the Transformer (a neural network with a multi-head attention mechanism) structure.

Operation S606: Update a predicted motion binding parameter between each local motion point and the corresponding base bone to a local motion binding parameter between the local motion point and the local base bone.

In some aspects, the processing device may update (that is, replace) the motion binding parameter (for example, the initial motion binding parameter) between each local motion point and the corresponding base bone predicted by using the skinning network with a local motion binding parameter (which may also be referred to as a motion binding parameter) between each local motion point and each local base bone predicted by using the local skinning network.

If optimization processing (that is, the related description for the collinear optimization part in the foregoing aspect corresponding to FIG. 3) further needs to be performed on a motion binding parameter predicted by a network (such as the skinning network and the local skinning network) by using corresponding straight line layouts, to implement collinear optimization on the motion points, optimization processing may also be performed on a motion binding parameter obtained after replacing (updating) the motion binding parameter between each local motion point and the corresponding base bone predicted by using the skinning network by using the local motion binding parameter between each local motion point and each local base bone predicted by using the local skinning network.

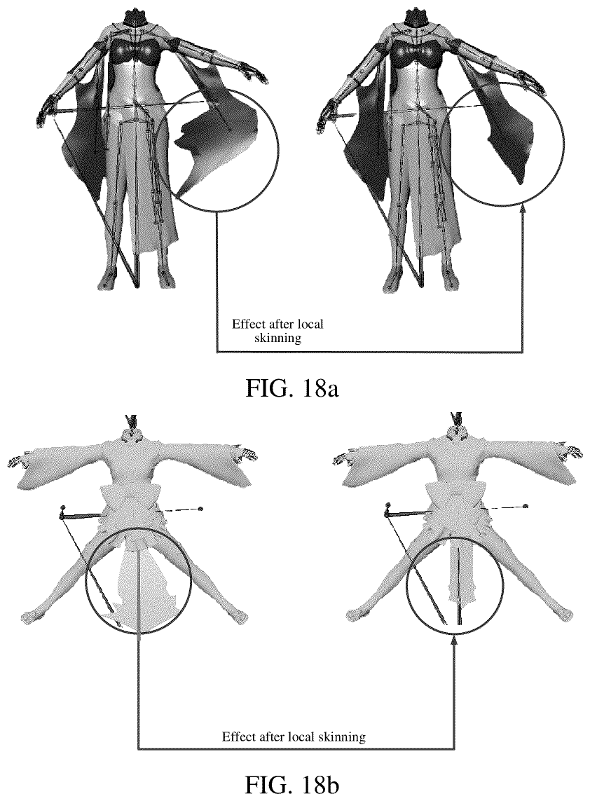

Referring to FIG. 18a to FIG. 18b, FIG. 18a is a schematic diagram 1 of an effect of local skinning according to an aspect described herein, and FIG. 18b is a schematic diagram 2 of an effect of local skinning according to an aspect described herein. For example, if the second object model is clothes in FIG. 18a, the left side may be a picture effect of not performing local skinning on the lower hem in a circle of the second object model, the right side may be a picture effect of performing local skinning on the lower hem in the circle of the second object model, and the lower hem in the circle of the right side is in a relatively regular drooping state.

For another example, if the second object model is clothes in FIG. 18b, the left side may be a picture effect of not performing local skinning on the skirt's hemline in a circle of the second object model, the right side may be a picture effect of performing local skinning on the skirt's hemline in the circle of the second object model, and the skirt's hemline in the circle of the right side is also in a relatively regular drooping state.

By means of the foregoing process described herein, first, global and universal accurate skinning may be performed between the first object model and the second object model by using the skinning network, and further, specific local skinning may be performed between the first object model and the second object model by using the local skinning network, to achieve various requirements on skinning the first object model and the second object model in an actual application scenario, thereby improving richness and accuracy of skinning performed between the first object model and the second object model, and improving a skinning effect.

In some aspects, the foregoing method provided described herein may be applied to any scenario in which one object model needs to move with another object model. The following describes, by using an example, a related scenario to which this application may be applied, but this application is not limited to the related scenarios described below.

The foregoing method provided described herein may be applied to a game scenario. The first object model and the second object model may both be virtual objects modeled in a game. The second object model may be an object needing to follow the first object model to move in the game. For example, the first object model may be a virtual game character or game monster in the game. The second object model may be virtual clothes worn by the game character or game monster, a virtual object (such as an accessory) carried by the game character or game monster, or the like. Therefore, by using the foregoing method provided described herein, a skinning operation between a game character in a game and virtual clothes worn by the game character can be implemented, so that motion of the game character can also drive motion of the virtual clothes worn by the game character, thereby implementing overall coordinated motion between the game character and the clothes worn by the game character.

The foregoing method provided described herein may be further applied to an animation generation scenario. The first object model and the second object model may be virtual objects in an animation (such as an animation film or an animation movie). The second object model may be an object needing to follow the first object model to perform motion in the animation. For example, the first object model may be a three-dimensional (3D) animation character modeled in the animation. The second object model may be simulated clothes worn by the animation character, a special effect dress up that follows the animation character to perform motion, or the like. Specifically, the first object model and the second object model may be determined according to an actual application scenario. Therefore, by using the foregoing method provided described herein, a skinning operation between the animation character in the animation and the simulated clothes worn by the animation character may also be implemented, so that motion of the animation character can also drive motion of the simulated clothes worn by the animation character, thereby implementing overall coordinated motion between the animation character and the clothes worn by the animation character.

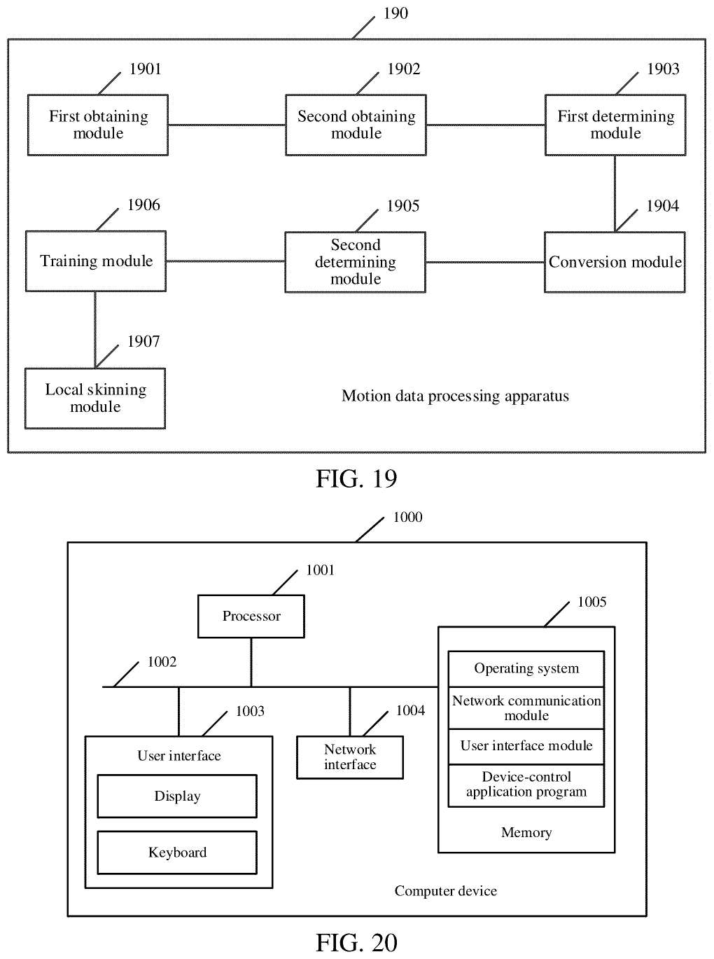

Referring to FIG. 19, FIG. 19 is a schematic structural diagram of a motion data processing apparatus according to an aspect described herein. The motion data processing apparatus 190 may include: a first obtaining module 1901, a second obtaining module 1902, a first determining module 1903, a conversion module 1904, and a second determining module 1905.

The first obtaining module 1901 is configured to obtain a first object model, the first object model including M base bones or some of the M base bones, and M being a natural number;
the second obtaining module 1902 is configured to obtain a second object model, the second object model including N motion points, each motion point of the N motion points respectively corresponding to one or more base bones of the M base bones, the N motion points being configured for defining motion of the second object model, and N being a natural number;
the first determining module 1903 is configured to determine a first reference position of each motion point and a second reference position of each base bone of the M base bones;
the conversion module 1904 is configured to perform conversion processing on the first reference position and the second reference position, to generate a global prediction feature corresponding to the N motion points, the global prediction feature being configured for reflecting a global position feature between the N motion points and corresponding base bones, position features of the M base bones, and structural features of bone chains in which the base bones corresponding to the N motion points are located; and
the second determining module 1905 is configured to determine a motion binding parameter between each motion point and a corresponding base bone based on the global prediction feature, any motion point in the N motion points being configured for following a corresponding base bone to motion according to a motion binding parameter between the motion point and the corresponding base bone.

In some aspects, the global prediction feature includes a motion point global feature of the N motion points, the motion point global feature is configured for reflecting a global position feature between the N motion points and corresponding base bones, and a process in which the conversion module 1904 generates the motion point global feature includes:
separately generating position association information between each motion point and a corresponding base bone based on the first reference position of the motion point and the second reference position of the base bone corresponding to the motion point;
performing feature embedding processing on position association information between the N motion points and the corresponding base bones to generate bone association features of the N motion points;
performing feature transform processing on the bone association features and the first reference positions of the N motion points, to generate motion point transform features of the N motion points; and
generating the motion point global feature based on the motion point transform features.

In some aspects, a manner in which the conversion module 1904 performs feature transform processing on the bone association features and the first reference positions of the N motion points, to generate the motion point transform features of the N motion points includes:
performing combination processing on the first reference positions of the N motion points and normal information of the N motion points, to generate basic features of the N motion points; and
performing fusion processing on the basic features and the bone association features to generate initial representation features of the N motion points; and
performing feature transform processing on the initial representation features, to generate the motion point transform features.

In some aspects, any one of the N motion points is a target motion point, and the motion point transform features include a transform feature of each motion point; and
a manner in which the conversion module 1904 generates the motion point global feature based on the motion point transform features includes:
selecting a plurality of neighboring motion points of the target motion point from the N motion points by using a plurality of neighbor selection manners;
performing feature embedding processing on a transform feature of the target motion point and a transform feature of each neighboring motion point separately, to generate a plurality of neighbor association features of the target motion point, and performing feature embedding processing on the transform feature of the target motion point and a transform feature of one neighboring motion point of the target motion point, to generate one neighbor association feature of the target motion point;
performing fusion processing on neighbor association features of the N motion points, to generate target neighboring features of the N motion points; and
performing feature reforming processing on the target neighboring features, to generate the motion point global feature.

In some aspects, a manner in which the conversion module 1904 performs feature reforming processing on the target neighboring features, to generate the motion point global feature includes:
obtaining motion point interaction features, and performing fusion processing on the target neighboring features and the motion point interaction features, to generate target motion point features, the motion point interaction features being obtained after performing feature interaction processing on position features of the N motion points and position features of the M bones; and
performing feature reforming processing on the target motion point features, to generate the motion point global feature.

In some aspects, any one of the N motion points is a target motion point; and
position association information between the target motion point and a corresponding base bone includes at least one of the following: relative position information between the target motion point and the corresponding base bone, an absolute distance between the target motion point and the corresponding base bone, and a shortest path distance between the target motion point and the corresponding base bone.

In some aspects, the global prediction feature includes bone position features of the M base bones, the bone position features are configured for reflecting position features of the M bones, and a process of generating the bone position features by the conversion module 1904 includes:
selecting a neighbor bone of each base bone from the M base bones;
separately performing concatenating processing on the second reference position of each base bone and a second reference position of the neighbor bone of the base bone to generate concatenating position information of the base bone;
performing feature embedding processing on concatenating position information of the M base bones to generate transition bone features of the M base bones; and
generating the bone position features based on the transition bone features.

In some aspects, a manner in which the conversion module 1904 generates the bone position features based on the transition bone features includes:
obtaining the basic features of the N motion points, the basic features being obtained after combination processing is performed on the first reference positions of the N motion points and the normal information of the N motion points; and
performing feature interaction processing on the basic features and the transition bone features to generate motion point interaction features of the N motion points and bone interaction features of the M base bones;
the bone position features being the bone interaction features.

In some aspects, the global prediction feature includes bone chain structural features associated with the N motion points, the bone chain structural features are configured for reflecting structural features of bone chains in which the base bones corresponding to the N motion points are located, and a process of generating the bone chain structural features by the conversion module 1904 includes:
obtaining an associated joint of each base bone on a bone chain on which the base bone is located, any bone chain including a plurality of base bones connected to each other, a joint of any bone chain referring to a bone connection between base bones included in the bone chain, and an associated joint of any base bone including one or more adjacent joints of the base bone on the bone chain on which the base bone is located;
separately performing combination processing on the second reference position of the base bone corresponding to each motion point and a third reference position of the associated joint of the base bone corresponding to the motion point, to obtain first bone chain information associated with the motion point;
performing combination processing on position distance information between each motion point and the corresponding base bone and position distance information between the motion point and the associated joint of the corresponding base bone, to obtain second bone chain information associated with the motion point; and
generating the bone chain structural feature based on the first bone chain information and the second bone chain information associated with each motion point.

In some aspects, a manner in which the conversion module 1904 generates the bone chain structural features based on the first bone chain information and the second bone chain information associated with each motion point includes:
performing feature embedding processing on first bone chain information associated with the N motion points, to generate first bone chain embedding features associated with the N motion points;
performing feature embedding processing on second bone chain information associated with the N motion points, to generate second bone chain embedding features associated with the N motion points; and
performing fusion processing on the first bone chain embedding features and the second bone chain embedding features to generate the bone chain structural features.

In some aspects, the global prediction feature is generated by invoking a skinning network; and
a manner in which the second determining module 1905 determine a motion binding parameter between each motion point and a corresponding base bone based on the global prediction feature includes:
invoking the skinning network to predict a motion binding parameter between each motion point and the corresponding base bone based on the global prediction feature.

In some aspects, a manner in which the second determining module 1905 invokes the skinning network to predict a motion binding parameter between each motion point and the corresponding base bone based on the global prediction feature includes:
invoking the skinning network to predict an initial motion binding parameter between each motion point and the corresponding base bone based on the global prediction feature;
calculating predicted motion positions of the N motion points in a plurality of target object postures of the first object model based on the initial motion binding parameter predicted for each motion point;
obtaining straight line layouts formed by the N motion points in the plurality of target object postures, and determining target posture positions of the N motion points in the plurality of target object postures based on the straight line layouts; and
performing optimization processing on initial motion binding parameters between the N motion points and the corresponding base bones based on differences between the predicted motion positions and the target posture positions of the N motion points in the plurality of target object postures, to generate motion binding parameters between the N motion points and the corresponding base bones; and
a process of performing optimization processing on initial motion binding parameters between the N motion points and the corresponding base bones includes: making the predicted motion positions of the N motion points in the plurality of target object postures to approach the target posture positions of the N motion points in the plurality of target object postures.

In some aspects, the motion data processing apparatus 190 further includes a training module 1906, and the training module 1906 is configured to:
obtain a first sample object model, the first sample object model including G sample base bones or some of the G sample base bones, and G being a natural number;
obtain a second sample object model, the second sample object model including K sample motion points, each sample motion point corresponding to one or more sample base bones of the G sample base bones, the K sample motion points being configured for defining motion of the second sample object model, K being a natural number, the K sample motion points each having a sample label, and a sample label of any sample motion point being configured for indicating a real motion binding parameter between the any sample motion point and a corresponding sample base bone;
determine a fourth reference position of each sample motion point and a fifth reference position of each sample base bone of the G sample base bones;
invoke a skinning network to be trained, and perform conversion processing on the fourth reference position and the fifth reference position, to generate a sample global prediction feature corresponding to the K sample motion points, the sample global prediction feature being configured for reflecting a global position feature between the K sample motion points and corresponding sample base bones, position features of the G sample base bones, and structural features of bone chains on which the sample base bones corresponding to the K sample motion points are located;
invoke the skinning network to be trained to predict a sample motion binding parameter between each sample motion point and the corresponding sample base bone based on the sample global prediction feature; and
correct, based on a difference between the sample motion binding parameter predicted for each sample motion point and a real motion binding parameter indicated by a sample label of each sample motion point, a network parameter of the skinning network to be trained, to obtain the skinning network.

In some aspects, a manner in which the training module 1906 corrects, based on a difference between the sample motion binding parameter predicted for each sample motion point and a real motion binding parameter indicated by a sample label of each sample motion point, a network parameter of the skinning network to be trained, to obtain the skinning network includes:
generating, based on the sample motion binding parameter and the real motion binding parameter corresponding to each sample motion point, a global parameter prediction deviation for the sample motion binding parameter and a motion position prediction deviation for the second sample object model;
generating a neighborhood parameter prediction deviation based on a difference between sample motion binding parameters corresponding to neighboring sample motion points in the K sample motion points and a difference between real motion binding parameters corresponding to neighboring sample motion points in the K sample motion points;
performing summation processing on the global parameter prediction deviation, the motion position prediction deviation, and the neighborhood parameter prediction deviation, to obtain target prediction deviations for the K sample motion points; and
correcting, based on the target prediction deviations, the network parameter of the skinning network to be trained, to obtain the skinning network.

In some aspects, a process of generating the motion position prediction deviation by the training module 1906 includes:
calculating a predicted motion position of each sample motion point based on the sample motion binding parameter predicted for each sample motion point, a start position of the sample motion point, and a motion parameter of a base bone corresponding to each sample motion point;
calculating a real motion position of each sample motion point based on the real motion binding parameter indicated by the sample label of the sample motion point, the start position of the sample motion point, and the motion parameter of the base bone corresponding to the sample motion point; and
generating the motion position prediction deviation based on the predicted motion position and the real motion position of each sample motion point.

In some aspects, a manner in which the training module 1906 generates a neighborhood parameter prediction deviation based on a difference between sample motion binding parameters corresponding to neighboring sample motion points in the K sample motion points and a difference between real motion binding parameters corresponding to neighboring sample motion points in the K sample motion points includes:
calculating a parameter distance between the sample motion binding parameter corresponding to each sample motion point and a sample motion binding parameter corresponding to an adjacent sample motion point of the sample motion point, to obtain predicted parameter distances corresponding to the K sample motion points;
calculating a parameter distance between the real motion binding parameter corresponding to each sample motion point and a real motion binding parameter corresponding to the adjacent sample motion point of the sample motion point, to obtain real parameter distances corresponding to the K sample motion points; and
generating the neighborhood parameter prediction deviation based on a difference between the predicted parameter distance and the real parameter distance.

In some aspects, the motion data processing apparatus 190 further includes a local skinning module 1907, and the local skinning module 1907 is configured to:
select a plurality of local motion points from the N motion points, and select a plurality of local base bones associated with the plurality of local motion points from the M base bones;
perform feature embedding processing on first reference positions of the plurality of local motion points, to generate motion point initial features of the plurality of local motion points;
perform feature embedding processing on second reference positions of the plurality of local base bones to generate bone initial features of the plurality of local base bones;
perform feature interaction processing on the bone initial features and the motion point initial features to generate first interaction features of the plurality of local motion points and second interaction features of the plurality of local base bones;
predict a local motion binding parameter between each local motion point and each local base bone based on the first interaction features and the second interaction features; and
update a predicted motion binding parameter between each local motion point and the corresponding base bone to a local motion binding parameter between the local motion point and the local base bone.

In some aspects, a manner in which the local skinning module 1907 predicts a local motion binding parameter between each local motion point and each local base bone based on the first interaction features and the second interaction features includes:
generating a first global feature of the plurality of local motion points, first local features of the plurality of local motion points, a second global feature of the plurality of local base bones, and second local features of the plurality of local base bones based on the first interaction features and the second interaction features, the first local features including a local feature of each local motion point, and the second local features including a local feature of each local base bone;
obtaining interaction feature distances between the first interaction features and the second interaction features; and
predicting a local motion binding parameter between each local motion point and each local base bone based on the interaction feature distances, the first global feature, the first local features, the second global feature, and the second local features.

In some aspects, a manner in which the local skinning module 1907 predicts a local motion binding parameter between each local motion point and each local base bone based on the interaction feature distances, the first global feature, the first local features, the second global feature, and the second local features includes:
performing concatenating processing on the first global feature and the first local features, to generate first concatenation features of the plurality of local motion points;
performing concatenating processing on the second global feature and the second local features to generate second concatenation features of the plurality of local base bones;
obtaining a first adjacency matrix of the plurality of local motion points, and obtaining a second adjacency matrix of the plurality of local base bones, the first adjacency matrix being configured for reflecting a connection relationship between the plurality of local motion points, and the second adjacency matrix being configured for reflecting a connection relationship between the plurality of local base bones; and
predicting the local motion binding parameter between each local motion point and each local base bone based on the first concatenation features, the second concatenation features, the first adjacency matrix, the second adjacency matrix, and the interaction feature distances.

In some aspects, a manner in which the local skinning module 1907 predicts the local motion binding parameter between each local motion point and each local base bone based on the first concatenation features, the second concatenation features, the first adjacency matrix, the second adjacency matrix, and the interaction feature distances includes:
performing a multiplication operation on the first concatenation features and the first adjacency matrix, to generate first adjacency features of the plurality of local motion points;
performing a multiplication operation on the second concatenation features and the second adjacency matrix to generate second adjacency features of the plurality of local base bones;
generating relative adjacency features between the plurality of local motion points and the plurality of local base bones based on differences between the first adjacency features and the second adjacency features;
performing concatenating processing on the relative adjacency features and the interaction feature distances, to generate local prediction features; and
predicting the local motion binding parameter between each local motion point and each local base bone based on the local prediction features.

In some aspects, the N motion points each have a respective start position; and the first determining module 1903 is configured to:
calculate a discrete curvature of each motion point based on the start position of each motion point and a start position of an adjacent motion point of the motion point; a discrete curvature of any motion point being configured for reflecting smoothness of a curved surface around the motion point;
obtain a plurality of reference curvatures, and perform smoothing processing on the start positions of the N motion points based on the plurality of reference curvatures and discrete curvatures of the N motion points, to generate smooth positions of the N motion points respectively at each reference curvature;
separately calculate an average curvature of the N motion points at each reference curvature based on the smooth positions of the N motion points at each reference curvature; and
use smooth positions of the N motion points at a reference curvature corresponding to a minimum average curvature as first reference positions of the N motion points;
any motion point being configured for moving with a corresponding base bone according to a motion binding parameter between the any motion point and the corresponding base bone and a start position of the any motion point.

In some aspects, any one of the plurality of reference curvatures is a target reference curvature; and a manner in which the first determining module 1903 performs smoothing processing on the start positions of the N motion points based on the plurality of reference curvatures and discrete curvatures of the N motion points, to generate smooth positions of the N motion points respectively at each reference curvature includes:
using a motion point that is in the N motion points and whose discrete curvature is greater than the target reference curvature as a motion point that needs to be adjusted;
performing smoothing processing on a start position of the motion point that needs to be adjusted, to generate a smoothed start position of the motion point that needs to be adjusted; and
determining a start position of a motion point in the N motion points other than the motion point that needs to be adjusted and the smoothed start position of the motion point that needs to be adjusted as smooth positions of the N motion points at the target reference curvature.

According to an aspect described herein, the operations involved in the motion data processing method shown in FIG. 3 may be performed by various modules in the motion data processing apparatus 190 shown in FIG. 19. For example, operation S101 shown in FIG. 3 may be performed by the first obtaining module 1901 in FIG. 19, operation S102 shown in FIG. 3 may be performed by the second obtaining module 1902 in FIG. 19, operation S103 shown in FIG. 3 may be performed by the first determining module 1903 in FIG. 19, operation S104 shown in FIG. 3 may be performed by the conversion module 1904 in FIG. 19, and operation S105 shown in FIG. 3 may be performed by the second determining module 1905 in FIG. 19.

Described herein, the first object model and the second object model may be obtained. The first object model may include the M base bones or some of the M base bones. The second object model may include the N motion points. Each motion point may correspond to one or more base bones of the M base bones. The N motion points may be configured for defining motion of the second object model. Therefore, described herein, feature embedding processing may be performed on the first reference positions of the N motion points and the second reference positions of the M bones, to generate the global prediction feature corresponding to the N motion points. The global prediction feature may be configured for reflecting a global position feature between the N motion points and corresponding base bones, position features of the M base bones, and structural features of bone chains in which the base bones corresponding to the N motion points are located. Therefore, described herein, a motion binding parameter between each motion point and a corresponding base bone may be determined based on the global prediction feature. Any motion point in the N motion points may move with a corresponding base bone based on a motion binding parameter between the motion point and the corresponding base bone. It can be learned that, in the method provided described herein, feature embedding processing may be performed on the first reference position of each motion point in the first object model and the second reference position of each motion point and the corresponding base bone in the second object model, to obtain the global prediction feature corresponding to the N motion points. The global prediction feature may include a plurality of features, such as a global position feature between a motion point and a corresponding base bone, position features of M bones, and structural features of bone chains in which the M bones are located. Subsequently, a motion binding parameter between each motion point and a corresponding base bone can be quickly and accurately determined by using the global prediction feature. Any motion point can accurately move with the corresponding base bone based on the motion binding parameter between the motion point and the corresponding base bone.

According to an aspect described herein, the modules in the motion data processing apparatus 190 shown in FIG. 19 may be separately or completely combined into one or more units, or one (some) of the units may be further divided into various functionally smaller subunits, so that the same operation can be implemented without affecting implementation of a technical effect of this aspect described herein. The foregoing modules are divided based on logical functions. In an actual application, a function of one module may also be implemented by a plurality of units, or functions of a plurality of modules are implemented by one unit. In another aspect described herein, the motion data processing apparatus 190 may alternatively include other units. In actual application, these functions may be implemented with the assistance of other units, and may be cooperatively implemented by a plurality of units.

According to an aspect described herein, the motion data processing apparatus 190 shown in FIG. 19 may be constructed by running, on a general-purpose computer device (the computer device may include a processing element and a storage element such as a central processing unit (CPU), a random access memory (RAM), and a read-only memory (ROM)), a computer program that can perform operations in a corresponding method shown in the aspects described herein. The computer program may be recorded in, for example, a computer-readable recording medium, and may be loaded into the foregoing computer device by using the computer-readable recording medium, and run in the computing device.

Referring to FIG. 20, FIG. 20 is a schematic structural diagram of a computer device according to an aspect described herein. As shown in FIG. 20, a computer device 1000 may include: a processor 1001, a network interface 1004, and a memory 1005. In addition, in some aspects, the computer device 1000 may further include: a user interface 1003, and at least one communication bus 1002. The communication bus 1002 is configured to implement connection and communication between these components. The user interface 1003 may include a display and a keyboard. In one aspect, the user interface 1003 may further include a standard wired interface and wireless interface. The network interface 1004 may include a standard wired interface and wireless interface (for example, a Wi-Fi interface). The memory 1005 may be a high-speed RAM memory, or may be a non-volatile memory, for example, at least one magnetic disk memory. In some aspects, the memory 1005 may alternatively be at least one storage apparatus away from the foregoing processor 1001. As shown in FIG. 20, the memory 1005 used as a computer storage medium may include an operating system, a network communication module, a user interface module, and a device-control application program.

In the computer device 1000 shown in FIG. 20, the network interface 1004 may provide a network communication function. The user interface 1003 is mainly configured to provide an input interface for a user. The processor 1001 may be configured to invoke the device-control application program stored in the memory 1005 to implement:
obtaining a first object model, the first object model including M base bones or some of the M base bones, and M being a natural number;
obtaining a second object model, the second object model including N motion points, each motion point of the N motion points respectively corresponding to one or more base bones of the M base bones, the N motion points being configured for defining motion of the second object model, and N being a natural number;
determining a first reference position of each motion point and a second reference position of each base bone of the M base bones;
performing conversion processing on the first reference position and the second reference position, to generate a global prediction feature corresponding to the N motion points, the global prediction feature being configured for reflecting a global position feature between the N motion points and corresponding base bones, position features of the M base bones, and structural features of bone chains in which the base bones corresponding to the N motion points are located; and
determining a motion binding parameter between each motion point and a corresponding base bone based on the global prediction feature, any motion point in the N motion points being configured for following a corresponding base bone to motion according to a motion binding parameter between the motion point and the corresponding base bone.

The computer device 1000 described in this aspect described herein may perform descriptions of the foregoing motion data processing methods in the aspects described herein, or may perform descriptions of the foregoing motion data processing apparatus 190 in the aspect corresponding to FIG. 19. Details are not described herein again. In addition, the description of beneficial effects of the same method are not described herein again.

In addition, this application further provides a computer-readable storage medium, and the computer-readable storage medium stores a computer program. When executing the computer program, a processor can perform the description of the motion data processing method in the aspects described herein. Therefore, details are not described herein again. In addition, the description of beneficial effects of the same method are not described herein again. For technical details that are not disclosed in the computer storage medium aspects described herein, refer to the descriptions of the method aspects described herein.

As an example, the computer program may be deployed to be executed on a computer device, or deployed to be executed on a plurality of computer devices at one position, or deployed to be executed on a plurality of computer devices that are distributed in a plurality of positions and interconnected through a communication network. The plurality of computer devices that are distributed in the plurality of positions and interconnected through the communication network may form a blockchain network.

The foregoing computer-readable storage medium may be an internal storage unit of the foregoing computer device, such as a hard disk or an internal memory of the computer device. The computer-readable storage medium may alternatively be an external storage device of the computer device, for example, a plug type hard disk, a smart media card (SMC), a secure digital (SD) card, and a flash card that are configured on the computer device. Further, the computer readable storage medium may further include an internal storage unit of the computer device and an external storage device. The computer-readable storage medium is configured to store the computer program and other programs and data that are required by the computer device. The computer-readable storage medium may be further configured to temporarily store data that has been or is to be output.

This application provides a computer program product, where the computer program product includes a computer program, and the computer program is stored in a computer readable storage medium. A processor of a computer device reads the computer program from the computer-readable storage medium, and the processor executes the computer program, so that the computer device executes descriptions of the foregoing motion data processing methods in the aspects described herein. Therefore, details are not described herein again. In addition, the description of beneficial effects of the same method are not described herein again. For technical details that are not disclosed in the aspects of the computer-readable storage medium included described herein, reference may be made to the descriptions about the method aspects described herein.

The terms “first” and “second” in the specification, claims, and accompanying drawings of the aspects described herein are configured for distinguishing between different objects, and are not configured for describing a specific sequence. In addition, the term “include” and any variant thereof are intended to cover a non-exclusive inclusion. For example, a process, method, apparatus, product, or device that includes a series of operations or units is not limited to the listed operations or modules; and instead, in some aspects, further includes an operation or module that is not listed, or in some aspects, further includes another operation or unit that is intrinsic to the process, method, apparatus, product, or device.

A person of ordinary skill in the art may be aware that, in combination with the examples described in the aspects disclosed in this specification, units and algorithm operation may be implemented by electronic hardware, computer software, or a combination thereof. To clearly describe the interchangeability between the hardware and the software, the foregoing has generally described compositions and operation of each example according to functions. Whether the functions are executed in a mode of hardware or software depends on particular applications and design constraint conditions of the technical solutions. Those skilled in the art may use different methods to implement the described functions for each particular application, but such implementation is not to be considered beyond the scope described herein.

What is disclosed above is merely illustrative aspects described herein, and certainly is not intended to limit the scope of the claims described herein. Therefore, equivalent variations made in accordance with the claims described herein shall fall within the scope described herein.

What is claimed is:

1. A computer-implemented method, comprising:
obtaining a first object model, the first object model comprising M base bones, where Mis a natural number;
obtaining a second object model, the second object model comprising N motion points, each motion point of the N motion points respectively corresponding to one or more base bones of the M base bones, the N motion points being configured for defining motion of the second object model, where N is a natural number;
determining a first reference position of each motion point and a second reference position of each base bone of the M base bones;
generating, based on the first reference positions and the second reference positions, a global prediction feature corresponding to the N motion points, the global prediction feature being configured based on the N motion points and corresponding base bones, position features of the M base bones, and structural features of bone chains in which the base bones corresponding to the N motion points are located; and
determining a motion binding parameter between each motion point and a corresponding base bone based on the global prediction feature, where any motion point in the N motion points is configured for following a corresponding base bone to motion according to a motion binding parameter between the motion point and the corresponding base bone.

2. The method according to claim 1, wherein: the global prediction feature comprises a motion point global feature of the N motion points, the motion point global feature is configured for reflecting a global position feature between the N motion points and corresponding base bones, and a process of generating the motion point global feature comprises:
separately generating position association information between each motion point and a corresponding base bone based on the first reference position of the motion point and the second reference position of the base bone corresponding to the motion point;
performing feature embedding processing on position association information between the N motion points and the corresponding base bones to generate bone association features of the N motion points;
performing feature transform processing on the bone association features and the first reference positions of the N motion points, to generate motion point transform features of the N motion points; and
generating the motion point global feature based on the motion point transform features.

3. The method of claim 2, wherein the performing feature transform processing on the bone association features and the first reference positions of the N motion points, to generate motion point transform features of the N motion points comprises:
performing combination processing on the first reference positions of the N motion points and normal information of the N motion points, to generate basic features of the N motion points;
performing fusion processing on the basic features and the bone association features to generate initial representation features of the N motion points; and
performing feature transform processing on the initial representation features, to generate the motion point transform features.

4. The method of claim 2, wherein any one of the N motion points is a target motion point, and the motion point transform features comprise a transform feature of each motion point; and
the generating the motion point global feature based on the motion point transform features comprises:
selecting a plurality of neighboring motion points of the target motion point from the N motion points by using a plurality of neighbor selection manners;
performing feature embedding processing on a transform feature of the target motion point and a transform feature of each neighboring motion point separately, to generate a plurality of neighbor association features of the target motion point, and performing feature embedding processing on the transform feature of the target motion point and a transform feature of one neighboring motion point of the target motion point, to generate one neighbor association feature of the target motion point;
performing fusion processing on neighbor association features of the N motion points, to generate target neighboring features of the N motion points; and
performing feature reforming processing on the target neighboring features, to generate the motion point global feature.

5. The method of claim 4, wherein the performing feature reforming processing on the target neighboring features, to generate the motion point global feature comprises:
obtaining motion point interaction features, and performing fusion processing on the target neighboring features and the motion point interaction features, to generate target motion point features, the motion point interaction features being obtained after performing feature interaction processing on position features of the N motion points and position features of the M bones; and
performing feature reforming processing on the target motion point features, to generate the motion point global feature.

6. The method of claim 1, wherein any one of the N motion points is a target motion point; and
position association information between the target motion point and a corresponding base bone comprises at least one of the following: relative position information between the target motion point and the corresponding base bone, an absolute distance between the target motion point and the corresponding base bone, and a shortest path distance between the target motion point and the corresponding base bone.

7. The method of claim 1, wherein the global prediction feature comprises bone position features of the M base bones, the bone position features are configured for reflecting position features of the M bones, and a process of generating the bone position feature comprises:
selecting a neighbor bone of each base bone from the M base bones;
separately performing concatenating processing on the second reference position of each base bone and a second reference position of the neighbor bone of the base bone to generate concatenating position information of the base bone;
performing feature embedding processing on concatenating position information of the M base bones to generate transition bone features of the M base bones; and
generating the bone position features based on the transition bone features.

8. The method of claim 7, wherein the generating the bone position features based on the transition bone features comprises:
obtaining the basic features of the N motion points, the basic features being obtained after combination processing is performed on the first reference positions of the N motion points and the normal information of the N motion points; and
performing feature interaction processing on the basic features and the transition bone features to generate motion point interaction features of the N motion points and bone interaction features of the M base bones;
the bone position features being the bone interaction features.

9. The method of claim 1, wherein the global prediction feature comprises bone chain structural features associated with the N motion points, the bone chain structural features are configured for reflecting structural features of bone chains in which the base bones corresponding to the N motion points are located, and a process of generating the bone chain structural feature comprises:
obtaining an associated joint of each base bone on a bone chain on which the base bone is located, any bone chain comprising a plurality of base bones connected to each other, a joint of any bone chain referring to a bone connection between base bones comprised in the bone chain, and an associated joint of any base bone comprising one or more adjacent joints of the base bone on the bone chain on which the base bone is located;
separately performing combination processing on the second reference position of the base bone corresponding to each motion point and a third reference position of the associated joint of the base bone corresponding to the motion point, to obtain first bone chain information associated with the motion point;
performing combination processing on position distance information between each motion point and the corresponding base bone and position distance information between the motion point and the associated joint of the corresponding base bone, to obtain second bone chain information associated with the motion point; and
generating the bone chain structural feature based on the first bone chain information and the second bone chain information associated with each motion point.

10. The method of claim 9, wherein the generating the bone chain structural feature based on the first bone chain information and the second bone chain information associated with each motion point comprises:
performing feature embedding processing on first bone chain information associated with the N motion points, to generate first bone chain embedding features associated with the N motion points;
performing feature embedding processing on second bone chain information associated with the N motion points, to generate second bone chain embedding features associated with the N motion points; and
performing fusion processing on the first bone chain embedding features and the second bone chain embedding features to generate the bone chain structural features.

11. The method of claim 1, wherein the global prediction feature is generated by invoking a skinning network; and
the determining a motion binding parameter between each motion point and a corresponding base bone based on the global prediction feature comprises:
invoking the skinning network to predict a motion binding parameter between each motion point and the corresponding base bone based on the global prediction feature.

12. The method of claim 11, wherein the invoking the skinning network to predict a motion binding parameter between each motion point and the corresponding base bone based on the global prediction feature comprises:
invoking the skinning network to predict an initial motion binding parameter between each motion point and the corresponding base bone based on the global prediction feature;
calculating predicted motion positions of the N motion points in a plurality of target object postures of the first object model based on the initial motion binding parameter predicted for each motion point;
obtaining straight line layouts formed by the N motion points in the plurality of target object postures, and determining target posture positions of the N motion points in the plurality of target object postures based on the straight line layouts; and
performing optimization processing on initial motion binding parameters between the N motion points and the corresponding base bones based on differences between the predicted motion positions and the target posture positions of the N motion points in the plurality of target object postures, to generate motion binding parameters between the N motion points and the corresponding base bones; and
a process of performing optimization processing on initial motion binding parameters between the N motion points and the corresponding base bones comprises: making the predicted motion positions of the N motion points in the plurality of target object postures to approach the target posture positions of the N motion points in the plurality of target object postures.

13. The method of claim 1, further comprising:
obtaining a first sample object model, the first sample object model comprising one or more G sample base bones, where G is a natural number;
obtaining a second sample object model, the second sample object model comprising K sample motion points, each sample motion point corresponding to one or more sample base bones of the G sample base bones, the K sample motion points being configured for defining motion of the second sample object model, K being a natural number, the K sample motion points each having a sample label, and a sample label of any sample motion point being configured for indicating a real motion binding parameter between the any sample motion point and a corresponding sample base bone;
determining a fourth reference position of each sample motion point and a fifth reference position of each sample base bone of the G sample base bones;
invoking a skinning network to be trained, and performing conversion processing on the fourth reference position and the fifth reference position, to generate a sample global prediction feature corresponding to the K sample motion points, the sample global prediction feature being configured for reflecting a global position feature between the K sample motion points and corresponding sample base bones, position features of the G sample base bones, and structural features of bone chains on which the sample base bones corresponding to the K sample motion points are located;
invoking the skinning network to be trained to predict a sample motion binding parameter between each sample motion point and the corresponding sample base bone based on the sample global prediction feature; and
correcting, based on a difference between the sample motion binding parameter predicted for each sample motion point and a real motion binding parameter indicated by a sample label of each sample motion point, a network parameter of the skinning network to be trained, to obtain the skinning network.

14. The method of claim 13, wherein the correcting, based on a difference between the sample motion binding parameter predicted for each sample motion point and a real motion binding parameter indicated by a sample label of each sample motion point, a network parameter of the skinning network to be trained, to obtain the skinning network comprises:
generating, based on the sample motion binding parameter and the real motion binding parameter corresponding to each sample motion point, a global parameter prediction deviation for the sample motion binding parameter and a motion position prediction deviation for the second sample object model;
generating a neighborhood parameter prediction deviation based on a difference between sample motion binding parameters corresponding to neighboring sample motion points in the K sample motion points and a difference between real motion binding parameters corresponding to neighboring sample motion points in the K sample motion points;
performing summation processing on the global parameter prediction deviation, the motion position prediction deviation, and the neighborhood parameter prediction deviation, to obtain target prediction deviations for the K sample motion points; and
correcting, based on the target prediction deviations, the network parameter of the skinning network to be trained, to obtain the skinning network.

15. The method of claim 14, wherein a process of generating the motion position prediction deviation comprises:
calculating a predicted motion position of each sample motion point based on the sample motion binding parameter predicted for each sample motion point, a start position of the sample motion point, and a motion parameter of a base bone corresponding to each sample motion point;
calculating a real motion position of each sample motion point based on the real motion binding parameter indicated by the sample label of the sample motion point, the start position of the sample motion point, and the motion parameter of the base bone corresponding to the sample motion point; and
generating the motion position prediction deviation based on the predicted motion position and the real motion position of each sample motion point.

16. The method of claim 14, wherein the generating a neighborhood parameter prediction deviation based on a difference between sample motion binding parameters corresponding to neighboring sample motion points in the K sample motion points and a difference between real motion binding parameters corresponding to neighboring sample motion points in the K sample motion points comprises:
calculating a parameter distance between the sample motion binding parameter corresponding to each sample motion point and a sample motion binding parameter corresponding to an adjacent sample motion point of the sample motion point, to obtain predicted parameter distances corresponding to the K sample motion points;
calculating a parameter distance between the real motion binding parameter corresponding to each sample motion point and a real motion binding parameter corresponding to the adjacent sample motion point of the sample motion point, to obtain real parameter distances corresponding to the K sample motion points; and
generating the neighborhood parameter prediction deviation based on a difference between the predicted parameter distance and the real parameter distance.

17. The method of claim 1, further comprising:
selecting a plurality of local motion points from the N motion points, and selecting a plurality of local base bones associated with the plurality of local motion points from the M base bones;
performing feature embedding processing on first reference positions of the plurality of local motion points, to generate motion point initial features of the plurality of local motion points;
performing feature embedding processing on second reference positions of the plurality of local base bones to generate bone initial features of the plurality of local base bones;
performing feature interaction processing on the bone initial features and the motion point initial features to generate first interaction features of the plurality of local motion points and second interaction features of the plurality of local base bones;
predicting a local motion binding parameter between each local motion point and each local base bone based on the first interaction features and the second interaction features; and
updating a predicted motion binding parameter between each local motion point and the corresponding base bone to a local motion binding parameter between the local motion point and the local base bone.

18. The method of claim 17, wherein the predicting a local motion binding parameter between each local motion point and each local base bone based on the first interaction features and the second interaction features comprises:
generating a first global feature of the plurality of local motion points, first local features of the plurality of local motion points, a second global feature of the plurality of local base bones, and second local features of the plurality of local base bones based on the first interaction features and the second interaction features, the first local features comprising a local feature of each local motion point, and the second local features comprising a local feature of each local base bone;
obtaining interaction feature distances between the first interaction features and the second interaction features; and
predicting a local motion binding parameter between each local motion point and each local base bone based on the interaction feature distances, the first global feature, the first local features, the second global feature, and the second local features.

19. The method of claim 17, wherein the predicting a local motion binding parameter between each local motion point and each local base bone based on the interaction feature distances, the first global feature, the first local features, the second global feature, and the second local features comprises:
performing concatenating processing on the first global feature and the first local features, to generate first concatenation features of the plurality of local motion points;
performing concatenating processing on the second global feature and the second local features to generate second concatenation features of the plurality of local base bones;
obtaining a first adjacency matrix of the plurality of local motion points, and obtaining a second adjacency matrix of the plurality of local base bones, the first adjacency matrix being configured for reflecting a connection relationship between the plurality of local motion points, and the second adjacency matrix being configured for reflecting a connection relationship between the plurality of local base bones; and
predicting the local motion binding parameter between each local motion point and each local base bone based on the first concatenation features, the second concatenation features, the first adjacency matrix, the second adjacency matrix, and the interaction feature distances.

20. The method of claim 17, wherein the predicting the local motion binding parameter between each local motion point and each local base bone based on the first concatenation features, the second concatenation features, the first adjacency matrix, the second adjacency matrix, and the interaction feature distances comprises:
performing a multiplication operation on the first concatenation features and the first adjacency matrix, to generate first adjacency features of the plurality of local motion points;
performing a multiplication operation on the second concatenation features and the second adjacency matrix to generate second adjacency features of the plurality of local base bones;
generating relative adjacency features between the plurality of local motion points and the plurality of local base bones based on differences between the first adjacency features and the second adjacency features;
performing concatenating processing on the relative adjacency features and the interaction feature distances, to generate local prediction features; and
predicting the local motion binding parameter between each local motion point and each local base bone based on the local prediction features.

21. The method of claim 1, wherein the N motion points each have a respective start position; and the method further comprises:
calculating a discrete curvature of each motion point based on the start position of each motion point and a start position of an adjacent motion point of the motion point; a discrete curvature of any motion point being configured for reflecting smoothness of a curved surface around the motion point;
obtaining a plurality of reference curvatures, and performing smoothing processing on the start positions of the N motion points based on the plurality of reference curvatures and discrete curvatures of the N motion points, to generate smooth positions of the N motion points respectively at each reference curvature;
separately calculating an average curvature of the N motion points at each reference curvature based on the smooth positions of the N motion points at each reference curvature; and
using smooth positions of the N motion points at a reference curvature corresponding to a minimum average curvature as first reference positions of the N motion points;
any motion point being configured for moving with a corresponding base bone according to a motion binding parameter between the any motion point and the corresponding base bone and a start position of the any motion point.

22. The method of claim 21, wherein any one of the plurality of reference curvatures is a target reference curvature; and the performing smoothing processing on the start positions of the N motion points based on the plurality of reference curvatures and discrete curvatures of the N motion points, to generate smooth positions of the N motion points respectively at each reference curvature comprises:
using a motion point that is in the N motion points and whose discrete curvature is greater than the target reference curvature as a motion point that needs to be adjusted;
performing smoothing processing on a start position of the motion point that needs to be adjusted, to generate a smoothed start position of the motion point that needs to be adjusted; and
determining a start position of a motion point in the N motion points other than the motion point that needs to be adjusted and the smoothed start position of the motion point that needs to be adjusted as smooth positions of the N motion points at the target reference curvature.
